(19) United States
(12) Patent Application Publication
(10) Pub. No.: US 2025/0358664 A1
(43) Pub. Date: Nov. 20, 2025

(54) TRIGGER CONDITIONS AND REPORT FORMATS FOR EVENT-DRIVEN REPORTING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/199,343

(22) Filed: May 5, 2025

Related U.S. Application Data
(60) Provisional application No. 63/649,155, filed on May 17, 2024.
(60) Provisional application No. 63/650,825, filed on May 22, 2024.

(51) Int. Cl. H04W 24/10; H04W 8/24

(52) U.S. Cl. CPC H04W 24/10; H04W 8/24

(57) ABSTRACT

Methods and apparatuses for trigger conditions and report formats for event-driven reporting. A method performed by a user equipment (UE) includes transmitting, in a capability signaling of the UE, an indication of support for event evaluation or measurement reporting for UE-initiated (UEI) reporting, receiving, in a channel state information (CSI) report configuration for UEI reporting, information related to an event, and receiving one or more first reference signals (RSs) associated with the CSI report configuration. The method further includes determining a second RS from the one or more first RSs, identifying, based on the information, an event type and an event evaluation threshold, Th_event, determining an event based on the event type, the event evaluation threshold, and the second RS, determining, based on the event, an UEI report including an identifier (ID) of the event, and transmitting the UEI report.

### CROSS-REFERENCE TO RELATED AND CLAIM OF PRIORITY

The present application claims priority under 35 U.S.C. § 119 (e) to U.S. Provisional Patent Application No. 63/649,155 filed on May 17, 2024 and U.S. Provisional Patent Application No. 63/650,825 filed on May 22, 2024, which are hereby incorporated by reference in their entirety.

### TECHNICAL FIELD

The present disclosure relates generally to wireless communication systems and, more specifically, the present disclosure relates to methods and apparatuses for trigger conditions and report formats for event-driven reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to trigger conditions and report formats for event-driven reporting.

In one embodiment, a user equipment (UE) is provided. The UE includes a transceiver configured to transmit, in a capability signaling of the UE, an indication of support for a synchronization signal/physical downlink broadcasting channel (SS/PBCH) block (SSB) or a channel state information reference signal (CSI-RS) for event evaluation or measurement reporting for UE-initiated (UEI) reporting, receive, in a channel state information (CSI) report configuration for UEI reporting, information related to an event, and receive one or more first reference signals (RSs) associated with the CSI report configuration. The UE further includes a processor operably coupled with the transceiver. The processor is configured to determine a second RS from the one or more first RSs, identify, based on the information, an event type and an event evaluation threshold, Th_event, determine an event based on the event type, the event evaluation threshold, and the second RS, and determine, based on the event, an UEI report including an identifier (ID) of the event. The transceiver is further configured to transmit the UEI report.

In another embodiment, a base station (BS) is provided. The BS includes a processor and a transceiver operably coupled with the processor. The transceiver is configured to receive, in a capability signaling of a UE, an indication of support for a SSB or a CSI-RS for event evaluation or measurement reporting for UEI reporting, transmit, in a CSI report configuration for UEI reporting, information related to an event, wherein the information indicates an event type and an event evaluation threshold, Th_event, transmit one or more first RSs associated with the CSI report configuration, and receive, after occurrence of the event, an UEI report including an ID of the event. The event is based on the event type, the event evaluation threshold, and a second RS from the one or more first RSs.

In yet another embodiment, a method performed by a UE is provided. The method includes transmitting, in a capability signaling of the UE, an indication of support for a SSB or a CSI-RS for event evaluation or measurement reporting for UEI reporting, receiving, in a CSI report configuration for UEI reporting, information related to an event, and receiving one or more first RSs associated with the CSI report configuration. The method further includes determining a second RS from the one or more first RSs, identifying, based on the information, an event type and an event evaluation threshold, Th_event, determining an event based on the event type, the event evaluation threshold, and the second RS, determining, based on the event, an UEI report including an ID of the event, and transmitting the UEI report. Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according and FIG. 5B illustrates an example of a multi-beam operation according to embodiments of the present disclosure;

FIG. 6 illustrates an example of a transmitter structure for beamforming according to embodiments of the present disclosure;

FIGS. 7A and 7B illustrate examples of UE-initiated (UEI) report format/content(s)/quantity(s) according to embodiments of the present disclosure; and

FIG. 8 illustrates an example method performed by a UE in a wireless communication system according to embodiments of the present disclosure.

### DETAILED DESCRIPTION

FIGS. 1-8, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v16.1.0, “NR; Physical channels and modulation;” [REF 2] 3GPP TS 38.212 v16.1.0, “NR; Multiplexing and Channel coding;” [REF 3] 3GPP TS 38.213 v16.1.0, “NR; Physical Layer Procedures for Control;” [REF 4] 3GPP TS 38.214 v16.1.0, “NR; Physical Layer Procedures for Data;” [REF 5] 3GPP TS 38.321 v16.1.0, “NR; Medium Access Control (MAC) protocol specification;” and [REF 6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for trigger conditions and report formats for event-driven reporting. In certain embodiments, one or more of the BSs 101-103 include circuitry, programing, or a combination thereof to utilize trigger conditions and report formats for event-driven reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

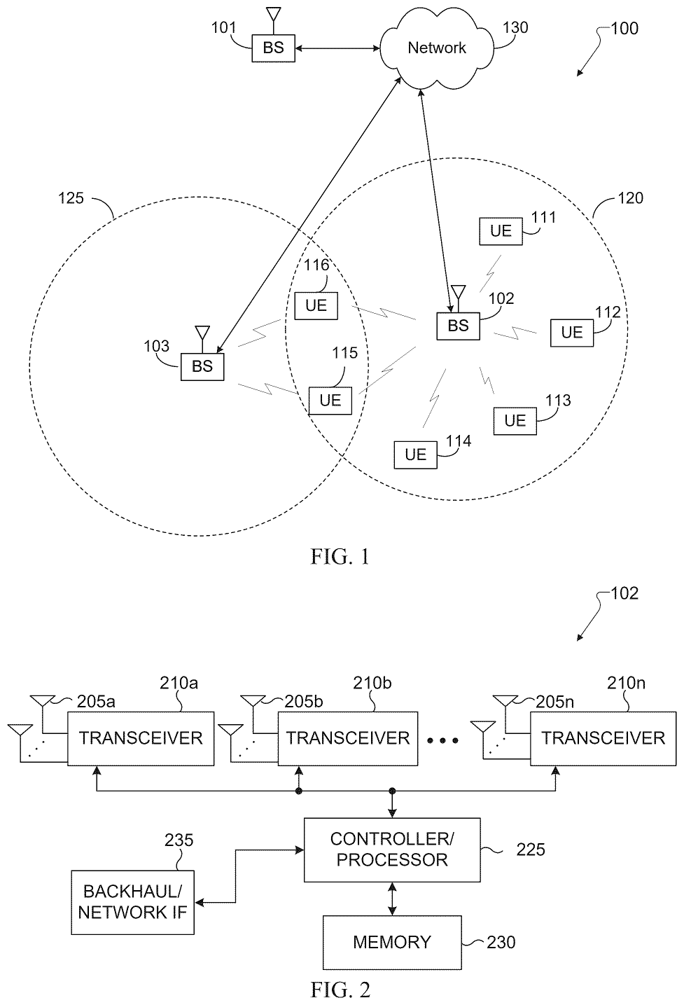

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as performing configurations supporting trigger conditions and report formats for event-driven reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver. The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

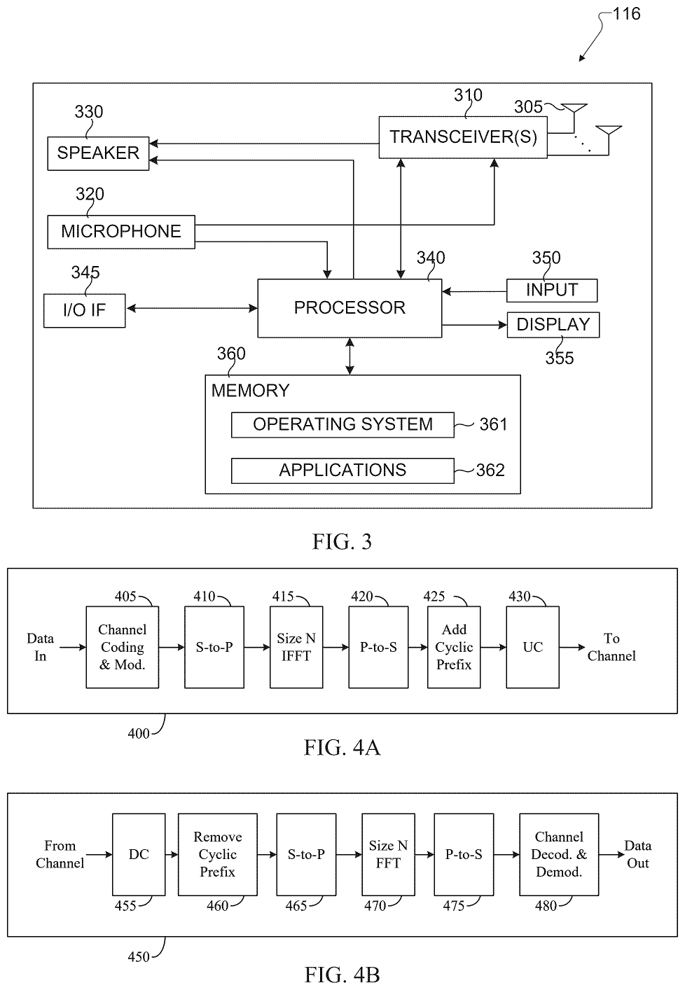

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to identify and report trigger conditions and report formats for event-driven reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support trigger conditions and report formats for event-driven reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

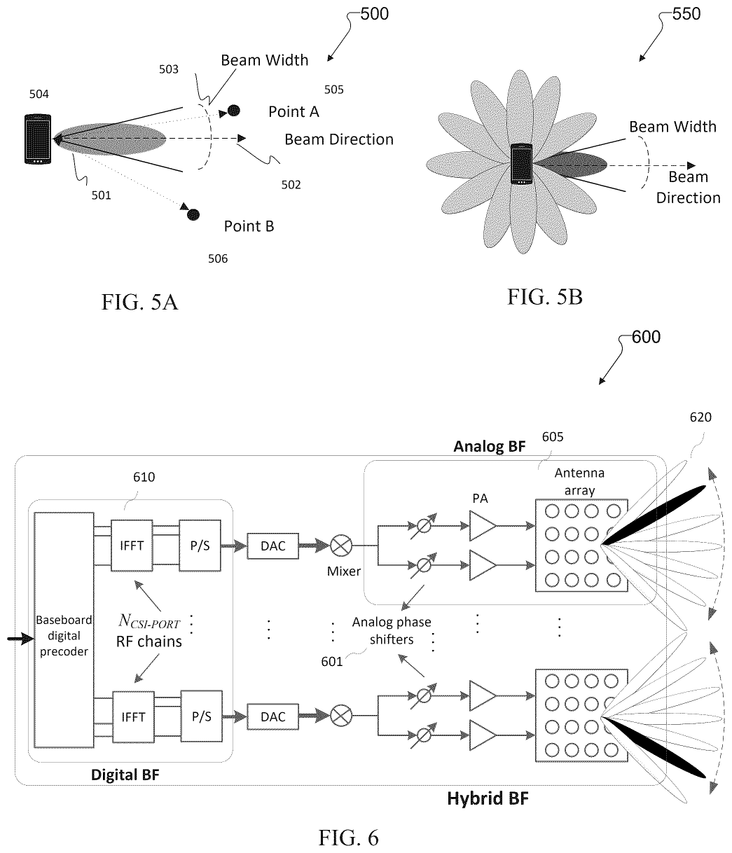

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication refence signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

In this disclosure, a beam can be determined by either of;
A transmission configuration indication (TCI) state, that establishes a quasi-colocation (QCL) relationship or spatial relation between a source reference signal (e.g. synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal or the ID of the TCI state or the ID of the spatial relation identifies the beam.

The TCI state and/or the spatial relation reference RS can determine a spatial Rx filter for reception of downlink channels at the UE, or a spatial TX filter for transmission of uplink channels from the UE.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB (e.g., the BS 102). Such UE-initiated reporting and/or beam switching for a content can be enabled for other types of report quantities (different from beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Therefore, embodiments of the present disclosure recognizes that there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate).

The present disclosure provides various detailed design examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated beam operations. In addition, the present disclosure also provides various report formats customized for the UE-initiated beam reporting, and specifies different conditions or settings to apply or use different report formats.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-)type (A), (B) and/or (C) according to one or more of:
Fixed rule(s) in system specification(s): for example, the UE (e.g., the UE 116) could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g. CRI, SSB resource indicator (SSBRI)) and Jᵢ is a beam metric (e.g. L1-reference signal received power (RSRP)/L1-signal-to-interference-plus-noise ratio (SINR)).
In one example, the content includes CSI-related quantity/quantities. For example, at least one of rank indicator (RI), precoding matrix indicator (PMI), channel quality indicator (CQI), CQI report interval (CRI), layer index (L1).
In one example, the content includes time-domain channel property (TDCP)-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-) correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception or/and UL transmission), or
      antenna (e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g. L1 DL/UL, or L1 sidelink (SL)), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| | | Trigger/pre- | |
| Event type | Type | notification message | Content |
| 0: beam | (A) | Yes (e.g. | No |
| | | beam-related event) | |
| | (B) | No | Yes |
| | (C) | Yes (e.g. | Yes |
| | | beam-related event) | |
| 1: CSI | (A) | Yes (e.g. | No |
| | | CSI-related event) | |
| | (B) | No | Yes |
| | (C) | Yes (e.g. | Yes |
| | | CSI-related event) | |
| 2: TDCP | (A) | Yes (e.g. | No |
| | | TDCP-related event) | |
| | (B) | No | Yes |
| | (C) | Yes (e.g. | Yes |
| | | TDCP-related event) | |
| 3: non-CSI/beam/TDCP | (A) | Yes (e.g. | No |
| | | non-CSI-related event) | |
| | (B) | No | Yes |
| | (C) | Yes (e.g. | Yes |
| | | non-CSI-related event) | |
| 4. other (content- | (A) | Yes (no | No |
| free/less events) | | need for content) | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| | Trigger/pre- | |
|---|---|---|
| Report-type | notification message | Content |
| (A) | Yes | No |
| (B) | No | Yes |
| (C) | Yes | Yes |

TABLE 4
event-based UE-initiated report
Report

| | Trigger/pre- | |
|---|---|---|
| Type | notification message | Content |
| 0 | Yes (e.g. beam-related event), | No |
| | content-specific or event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| | Trigger/pre- | |
|---|---|---|
| Type | notification message | Content |
| 0 | Yes (content- | No |
| | agnostic/transparent) | |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (cyclic delay diversity (CDD), cycling, space frequency block code (SFBC)), reciprocity (NCB, or non-PMI-feedback), or based on partial CSI (e.g. CRI-il or CRI-il-CQI or L1-CRI-il or L1-CRI-il-CQI), or based on single TRP to multi-TRP switch (or vice versa).
For another example, the hint (or purpose of the PN message/trigger as specified herein in the present disclosure) is about transmission parameters, e.g. modulation and coding scheme (MCS), or number of carrier waves (CWs).
For another example, when there is no pre-notification message/trigger associated with a content, i.e., the report-type is (B), the content can be transmitted using UL resource(s) configured (e.g. configured-grant physical uplink shared channel (PUSCH)), or reserved for the UE-initiated report, or via a random access channel (RACH) procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE (e.g., the UE 116) could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE (e.g., the UE 116) could send to the network (e.g., the network 130) UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, uplink control information (UCI) and etc.

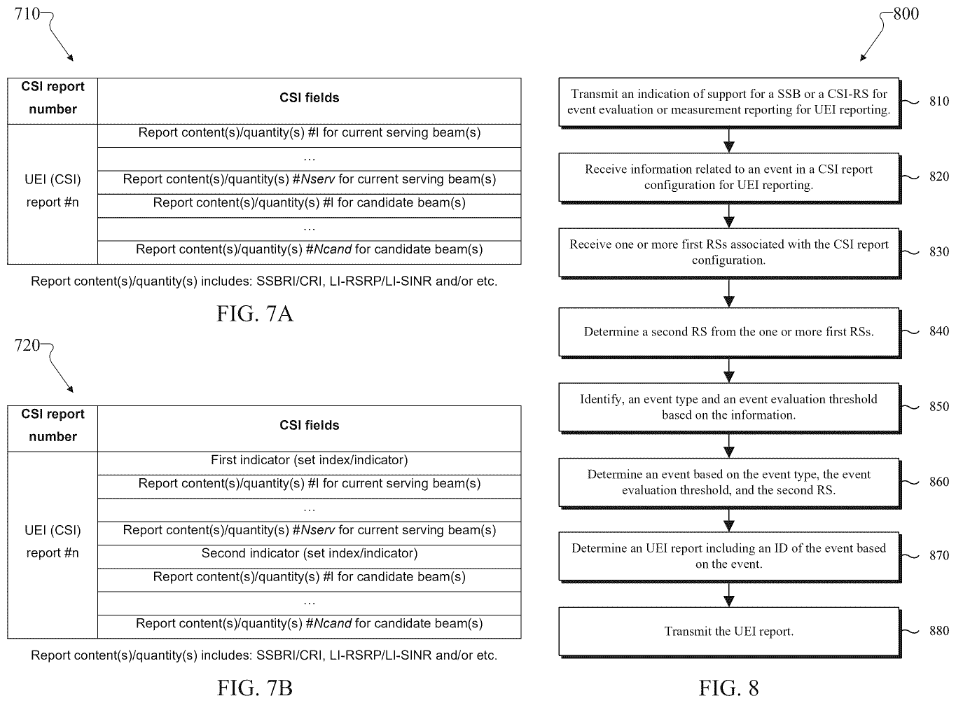

FIGS. 7A and 7B illustrate examples of UEI report format/content(s)/quantity(s) 710 and 720 according to embodiments of the present disclosure. For example, UEI report format/content(s)/quantity(s) 710 and 720 can be reported by any of the UEs 111-116 of FIG. 1. This example is for illustration only and other embodiments can be used without departing from the scope of the present disclosure.

In one embodiment, the UEI report could comprise (1) report content(s)/quantity(s) including resource indicators including SSBRI(s) and/or CRI(s) and the corresponding beam metric(s) including L1-RSRP(s)/L1-SINR(s) for current serving beam(s) only, (2) report content(s)/quantity(s) including resource indicators including SSBRI(s) and/or CSI(s) and the corresponding beam metric(s) including L1-RSRP(s)/L1-SINR(s) for candidate beam(s) only, and/or (3) report quantity(s)/content(s) including resource indicators including SSBRI(s) and/or CSI(s) and the corresponding beam metric(s) including L1-RSRP(s)/L1-SINR(s) for both current serving beam(s) and candidate beam(s).

For example, the UE could be provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, whether or not the UEI report should or could comprise (1), (2) and/or (3) as described herein; for instance, when/if a higher layer RRC signaling/parameter denoted by ‘servBeamInclusion’ is provided or configured, the UEI report could or should comprise (1) and/or (3); otherwise, the UEI report could or should comprise (2). Alternatively, when/if a higher layer RRC signaling/parameter, e.g., denoted by ueiReportContent is set to ‘servBeamOnly’, the UEI report could or should comprise (1), when/if the higher layer RRC signaling/parameter ueiReportContent is set to ‘candBeamOnly’, the UEI report could or should comprise (2), and/or when/if the higher layer RRC signaling/parameter ueiReportContent is set to ‘bothServAndCandBeam’, the UEI report could or should comprise (3). In this case, for (3), i.e., when/if the UE is configured to send a UEI report comprising report quantity(s)/content(s)—including resource indicator(s) such as SSBRI(s)/CRI(s) and/or beam metric(s) such as L1-RSRP(s)/L1-SINR(s)—for both the current serving beam(s) and the candidate beam(s), the UE could be further provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, the position(s)/ordering(s)/CSI report number(s)/CSI report index(es)/CSI report field(s) of the report content(s)/quantity(s) for the current serving beam(s) and/or the report content(s)/quantity(s) for the candidate beam(s) in the UEI report(s).

For another example, the UE could autonomously determine, select or decide whether or not the UEI report should or could comprise (1), (2) and/or (3) as described herein, and indicate to the network, e.g., in/by part of the UEI report including the PN message, their determination or selection or decision.
In one example, the UE could send to the network a/the PN message to indicate to the network whether or not the UEI report comprises (1), (2) and/or (3) as described herein. For instance, the PN message could be or could comprise a one-bit indicator; when/if the one-bit indicator is set to ‘0’ (or ‘1’), the UEI report comprises (1) and/or (3); otherwise, the UEI report comprises (2). Alternatively, the PN message could be or could comprise a multi-bit indicator (e.g., a two-bit indicator); when/if the two-bit indicator is set to ‘00’ (‘01’, ‘10’ or ‘11’), the UEI report comprise (1), when/if the two-bit indicator is set to ‘01’ (‘00’, ‘10’ or ‘11’), the UEI report comprises (2), and/or when/if the two-bit indicator is set to ‘10’ or ‘11’ (‘00’ or ‘01’), the UEI report comprises (3).
In another example, the PN message could be or could comprise a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
In another example, each of the report content(s)/quantity(s) including a resource indicator such as a SSBRI/CRI or a beam metric such as a L1-RSRP/L1-SINR in a UEI report could be associated with an indicator provided in the same UEI report. In this case, the indicator could be a one-bit indicator; when/if the one-bit indicator is set to ‘0’ (or ‘1’), the resource indicator (including SSBRI and/or CRI) and/or the beam metric (including L1-RSRP and/or L1-SINR) associated/corresponding to the one-bit indicator could correspond to a current serving beam, and/or when/if the one-bit indicator is set to ‘1’ (or ‘0’), the resource indicator (including SSBRI and/or CRI) and/or the beam metric (including L1-RSRP and/or L1-SINR) associated/corresponding to the one-bit indicator could correspond to a candidate beam.
In another example, each of the report content(s)/quantity(s) including a resource indicator such as a SSBRI/CRI or a beam metric such as a L1-RSRP/L1-SINR in a UEI report could be associated with an on/off indicator provided in the same UEI report. In this case, when/if the indicator is on or present in the UEI report or set to ‘on’, the resource indicator (including SSBRI and/or CRI) and/or the beam metric (including L1-RSRP and/or L1-SINR) associated/corresponding to the indicator could correspond to a current serving beam, and/or when/if the indicator is off or absent from the UEI report or set to ‘off’, the resource indicator (including SSBRI and/or CRI) and/or the beam metric (including L1-RSRP and/or L1-SINR) associated/corresponding to the indicator could correspond to a candidate beam.
In another example, for (3), position(s)/ordering(s)/CSI report number(s)/CSI report index(es)/CSI report field(s) of the report content(s)/quantity(s) including resource indicator(s) such as SSBRI(s)/CRI(s) and/or beam metric(s) such as L1-RSRP(s)/L1-SINR(s) corresponding to current serving beam(s) and/or candidate beam(s) in the UEI report(s) could be fixed/predetermined/predefined. For instance, denote the number of the report content(s)/quantity(s) including resource indicator(s) such as SSBRI(s)/CRI(s) and/or beam metric(s) such as L1-RSRP(s)/L1-SINR(s) corresponding to current serving beam(s) by Nserv, the first (or last) Nserv position(s)/ordering(s)/CSI report number(s)/CSI report index(es)/CSI report field(s) in a/the UEI report could be used to carry or convey the report content(s)/quantity(s) for the current serving beam(s), and the rest of the position(s)/ordering(s)/CSI report number(s)/CSI report index(es)/CSI report field(s) in the same UEI report could be used to carry or convey the report content(s)/quantity(s) for the candidate beam(s). Alternatively, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) by Ncand, the first (or last) Ncand position(s)/ordering(s)/CSI report number(s)/CSI report index(es)/CSI report field(s) in a/the UEI report could be used to carry or convey the report content(s)/quantity(s) for the candidate beam(s), and the rest of the position(s)/ordering(s)/CSI report number(s)/CSI report index(es)/CSI report field(s) in the same UEI report could be used to carry or convey the report content(s)/quantity(s) for the serving beam(s). One conceptual example characterizing the UEI reporting format described/specified herein in the present disclosure is presented in FIG. 6a.
In another example, for (3), a first indicator and/or a second indicator could be provided, reported, sent, comprised, included, contained or transmitted in a/the UEI report as specified herein in the present disclosure. For this design example, the first indicator could be specific/associated/corresponding to or could be used to indicate a serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure, and/or the second indicator could be specific/associated/corresponding to or could be used to indicate a candidate beam(s) RS set and/or information related to report content(s)/quantity(s) including resource indicator(s) such as SSBRI(s)/CRI(s) and/or beam metric(s) such as L1-RSRP(s)/L1-SINR(s) for one or more candidate beams according to those specified herein in the present disclosure. In particular, the first indicator could correspond to a set index/indicator for a serving beam(s) RS set denoted by 5, according to those specified herein in the present disclosure—e.g., the set index/indicator for the serving beam(s) RS set, and therefore, the first indicator, could be ‘0’ (or ‘1’ or ‘2’); optionally or alternatively, the first indicator could correspond to a one-bit indicator (e.g., a one-bit set index/indicator) with ‘0’ (or ‘1’ or ‘2’) corresponding to/indicating the serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure. Furthermore, the second indicator could correspond to a set index/indicator for a candidate beam(s) RS set denoted by \vec{s}₁ according to those specified herein in the present disclosure—e.g., the set index/indicator for the candidate beam(s) RS set, and therefore, the second indicator, could be ‘1’ (or ‘0’ or ‘2’); optionally or alternatively, the second indicator could correspond to a one-bit indicator (e.g., a one-bit set index/indicator) with ‘1’ (or ‘0’ or ‘2’) corresponding to/indicating the candidate beam(s) RS set and/or information related to report content(s)/quantity(s) including resource indicator(s) such as SSBRI(s)/CRI(s) and/or beam metric(s) such as L1-RSRP(s)/L1-SINR(s) for the candidate beam(s) according to those specified herein in the present disclosure. Denote the number of the report content(s)/quantity(s) including resource indicator(s) such as SSBRI(s)/CRI(s) and/or beam metric(s) such as L1-RSRP(s)/L1-SINR(s) corresponding to current serving beam(s) in a/the UEI report by Nserv, the first Nserv CSI fields in the UEI report following the CSI field that provides, carries or conveys the first indicator could be used to provide, carry or convey the Nserv report content(s)/quantity(s) specific to/for the current serving beam(s). In addition, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) in a/the UEI report by Ncand, the first Ncand CSI fields in the UEI report following the CSI field that provides, carries or conveys the second indicator could be used to provide, carry or convey the Ncand report content(s)/quantity(s) specific to/for the candidate beam(s). The CSI field that provides, carries or conveys the first indicator in a/the UEI report, and/or the CSI field that provides, carries or conveys the second indicator in a/the UEI report, could be fixed—e.g., the CSI field that provides, carries or conveys the first (or second) indicator could correspond to the first (or 1^{st}) CSI field in a/the UEI report, and/or the CSI field that provides, carries or conveys the second (or first) indicator could correspond the first (or 1^{st}) CSI field that follows or is after the last CSI field that provides, carries or conveys the report content(s)/quantity(s) including resource indicator(s) SSBRI(s)/CRI(s) and/or beam metric(s) such as L1-RSRP(s)/L1-SINR(s) corresponding to the current serving (or candidate) beam(s)—in FIG. 6b, a conceptual example capturing the UEI reporting format according to those specified herein in the present disclosure is provided. Furthermore, the CSI field that provides, carries or conveys the first indicator in a/the UEI report, and/or the CSI field that provides, carries or conveys the second indicator in a/the UEI report, could be determined according to/based on (i) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (ii) UE's autonomous determination/selection, which could be further sent to the network via various UL channels/signals including PUCCH, PUSCH, PRACH, and/or etc.
In another example, for (3), each of the report contents/quantities (such as resource indicators SSBRIs/CRIs and/or beam metrics L1-RSRPs/L1-SINRs) in a UEI report could be associated/corresponding/specific to an indicator, which could be conveyed, provided, indicated, contained, included or comprised in the (same) UEI report. For example, the indicator could correspond to a set index/indicator for a serving beam(s) RS set denoted by s̅₀ according to those specified herein in the present disclosure or a candidate beam(s) RS set denoted by s̅₁ according to those specified herein in the present disclosure—e.g., the indicator (or equivalently, the set index/indicator) could be ‘0’ (or ‘1’ or ‘2’) for the serving beam(s) RS set, and ‘1’ (or ‘0’ or ‘2’) for the candidate beam(s) RS set. For another example, the indicator could correspond to a one-bit indicator with ‘0’ (or ‘1’ or ‘2’) corresponding to/indicating the serving beam(s) RS set and/or information related to current serving beam(s), and ‘1’ (or ‘0’ or ‘2’) corresponding to/indicating the candidate beam(s) RS set and/or information related to candidate beam(s). In this case, when/if an indicator associated/corresponding/specific to a report content/quantity as specified/defined herein in the present disclosure in a UEI report is set to ‘0’ (or ‘1’ or ‘2’), the report content/quantity could be associated/corresponding/specific to the current serving beam(s), and when/if an indicator associated/corresponding/specific to a report content/quantity as specified/defined herein in the present disclosure in a UEI report is set to ‘1’ (or ‘0’ or ‘2’), the report content/quantity could be associated/corresponding/specific to the candidate beam(s).
In another example, the UEI report could comprise, include, provide, contain or indicate a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
In another example, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a first (RSRP/SINR) threshold. In this case, when/if a beam metric such as a L1-RSRP or a L1-SINR reported in the UEI report is below (or beyond) the first threshold, the report content(s)/quantity(s) including a resource indicator such as a SSBRI or a CRI associated/corresponding to the beam metric could be or could correspond to a serving beam. Optionally, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a second (RSRP/SINR) threshold. In this case, when/if a beam metric such as a L1-RSRP or a L1-SINR reported in the UEI report is beyond (or below) the second threshold, the report content(s)/quantity(s) including a resource indicator such as a SSBRI or a CRI associated/corresponding to the beam metric could be or could correspond to a candidate beam.

In the design examples specified/described herein in the present disclosure, the value(s) of Nserv and/or Ncand could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). For instance, the UE could send or transmit PN message(s) to indicate the value(s) of Nserv and/or Ncand, and/or to indicate information related to the value(s) of Nserv and/or Ncand, wherein the PN message(s) could be in part 1 of a two-part UEI report (or a two-part UCI). Optionally, according to those specified herein in the present disclosure, a UEI report could comprise a mixture of both CRI(s) and SSBRI(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the CRI(s) and/or SSBRI(s) reported in the same UEI report. In addition, one or more of the resource indicators reported in the UEI report could be associated or corresponding or specific to an indicator (provided, indicated, contained, included or comprised in the same UEI report). The indicator(s) could indicate whether the resource indicator(s) associated or corresponding or specific to the indicator(s) is CRI(s) or SSBRI(s). For instance, the indicator(s) could be one-bit indicator(s), and when/if an indicator is set to ‘0’ (or ‘1’), the resource indicator(s) associated or corresponding or specific to the indicator in a UEI report could correspond to a SSBRI, and when/if an indicator is set to ‘1’ (or ‘0’), the resource indicator(s) associated or corresponding or specific to the indicator in the UEI report could correspond to a CRI. Furthermore, a UEI report could also comprise a mixture of both L1-RSRP(s) and L1-SINR(s). For this case, the UE (e.g., the UE 116) could indicate to the network, e.g., via/in part of the UEI report—for instance, via/by/in the PN message wherein the PN message could be in part 1 of a two-part UEI report (or a two-part UCI), the number(s)/value(s)/quantity(s) of the L1-RSRP(s) and/or L1-SINR(s) reported in the same UEI report. In addition, one or more of the radio link/beam quality(s) or metric(s) reported in the UEI report could be associated or corresponding or specific to an indicator (provided, indicated, contained, included or comprised in the same UEI report). The indicator(s) could indicate whether the radio link/beam quality(s)/metric(s) associated or corresponding or specific to the indicator(s) is L1-RSRP(s) or L1-SINR(s). For instance, the indicator(s) could be one-bit indicator(s), and when/if an indicator is set to ‘0’ (or ‘1’), the radio link/beam quality(s)/metric(s) associated or corresponding or specific to the indicator in a UEI report could correspond to a L1-RSRP, and when/if an indicator is set to ‘1’ (or ‘0’), the radio link/beam quality(s)/metric(s) associated or corresponding or specific to the indicator in the UEI report could correspond to a L1-SINR.

For a first event (denoted by Event-1), wherein the radio link or beam quality(s) of one or more current serving beams is below or less than or equal to a threshold-A (an instance for the first event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s). In this case, a/the UEI report, e.g., for the first event, could comprise one or more of the following components for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure:
Component-1a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-1b: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-1c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1a for the one or more first current serving beams; differential RSRP/SINR reporting could be applied to Component-1c according to those specified herein in the present disclosure.
Component-1d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1b for the one or more second current serving beams; differential RSRP/SINR reporting could be applied to Component-1d according to those specified herein in the present disclosure.
Component-1e: indicator(s) or bitmap(s) indicating the one or more first current serving beams—e.g., out of the current serving beams
Component-1f: indicator(s) or bitmap(s) indicating the one or more second current serving beams—e.g., out of the current serving beams or out of the first current serving beam(s)
Component-1g: a number of the one or more first current serving beams in the UEI report(s)
Component-1h: a number of the one or more second current serving beams in the UEI report(s)
Component-1i: indicator(s) indicating occurrence of the first event and/or an event index/ID associated/specific/corresponding to the first event
Component-1j: difference(s) between the beam metric(s) such as L1-RSRP(s)/L1-SINR(s) for the one or more first current serving beams and the threshold-A; For instance, if a (differential) L1-RSRP/L1-SINR value computed with respect to or regarding or for a first current serving beam is x dBm, and the threshold-A is y dBm, a difference delta_diff_A=|x−y| dBm could be reported in the UEI report as a report content/quantity, and a corresponding one-bit sign indicator indicating either positive or negative of the difference could also be reported in the same UEI report. Or, the difference delta_diff_A=(x−y) and/or (y−x) dBm could be reported in the UEI report as a report content/quantity. Optionally, the value of delta_diff_A could be quantized to a u-bit value with a v dB step size with respect to the threshold-A.
Component-1k: difference(s) between the beam metric(s) such as L1-RSRP(s)/L1-SINR(s) for the one or more second current serving beams and the threshold-A; For instance, if a (differential) L1-RSRP/L1-SINR value computed with respect to or regarding or for a second current serving beam is x′ dBm, and the threshold-A is y dBm, a difference delta_diff_A′=|x′−y| dBm could be reported in the UEI report as a report content/quantity, and a corresponding one-bit sign indicator indicating either positive or negative of the difference could also be reported in the same UEI report. Or, the difference delta_diff_A′=(x′−y) and/or (y−x′) dBm could be reported in the UEI report as a report content/quantity.
Component-1l: indicator(s) indicating presence or absent of Component-1a in the UEI report(s); e.g., the indicator(s) could be a one-bit indicator with ‘1’ (or ‘0’) indicating presence and ‘0’ (or ‘1’) indicating absence of Component-1a in the UEI report(s). Optionally, the value of delta_diff_A′ could be quantized to a u-bit value with a v dB step size with respect to the threshold-A.
Component-1m: indicator(s) indicating presence or absent of Component-1b in the UEI report(s); e.g., the indicator(s) could be a one-bit indicator with ‘1’ (or ‘0’) indicating presence and ‘0’ (or ‘1’) indicating absence of Component-1b in the UEI report(s).
Component-1n: indicator(s) indicating presence or absent of Component-1c in the UEI report(s); e.g., the indicator(s) could be a one-bit indicator with ‘1’ (or ‘0’) indicating presence and ‘0’ (or ‘1’) indicating absence of Component-1c in the UEI report(s).
Component-1o: indicator(s) indicating presence or absent of Component-1d in the UEI report(s); e.g., the indicator(s) could be a one-bit indicator with ‘1’ (or ‘0’) indicating presence and ‘0’ (or ‘1’) indicating absence of Component-1d in the UEI report(s).
Component-1p: indicator(s) indicating presence or absence of Component-1j in the UEI report(s); e.g., the indicator(s) could be a one-bit indicator with ‘1’ (or ‘0’) indicating presence and ‘0’ (or ‘1’) indicating absence of Component-1j in the UEI report(s).
Component-1q: indicator(s) indicating presence or absence of Component-1k in the UEI report(s); e.g., the indicator(s) could be a one-bit indicator with ‘1’ (or ‘0’) indicating presence and ‘0’ (or ‘1’) indicating absence of Component-1k in the UEI report(s).

The value(s) of threshold-A, threshold-A′, Ns, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. In one example, Ns>1. In another example, Ns≥1.

For a second event (denoted by Event-2), wherein the radio link or beam quality(s) of one or more candidate beams is beyond or greater than or equal to a threshold-B (an instance for the second event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s)—throughout the present disclosure, a candidate beam is equivalent to a candidate new beam or a new beam. In this case, a/the UEI report, e.g., for the second event, could comprise one or more of the following components for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure:
Component-2a: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-2b: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-2c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2a for the one or more first candidate beams; differential RSRP/SINR reporting could be applied to Component-2c according to those specified herein in the present disclosure.
Component-2d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2b for the one or more second candidate beams; differential RSRP/SINR reporting could be applied to Component-2d according to those specified herein in the present disclosure.
Component-2e: indicator(s) or bitmap(s) indicating the one or more first candidate beams—e.g., out of the candidate beams
Component-2f: indicator(s) or bitmap(s) indicating the one or more second candidate beams—e.g., out of the candidate beams or out of the first candidate beam(s)
Component-2g: a number of the one or more first candidate beams in the UEI report(s)
Component-2h: a number of the one or more second candidate beams in the UEI report(s)
Component-2i: indicator(s) indicating occurrence of the second event and/or an event index/ID associated/specific/corresponding to the second event
Component-2j: difference(s) between the beam metric(s) such as L1-RSRP(s)/L1-SINR(s) for the one or more first candidate beams and the threshold-B; For instance, if a (differential) L1-RSRP/L1-SINR value computed with respect to or regarding or for a first candidate beam is x dBm, and the threshold-B is y dBm, a difference delta_diff_B=|x−y| dBm could be reported in the UEI report as a report content/quantity, and a corresponding one-bit sign indicator indicating either positive or negative of the difference could also be reported in the same UEI report. Or, the difference delta_diff_B=(x−y) and/or (y−x) dBm could be reported in the UEI report as a report content/quantity. Optionally, the value of delta_diff_B could be quantized to a u-bit value with a v dB step size with respect to the threshold-B.
Component-2k: difference(s) between the beam metric(s) such as L1-RSRP(s)/L1-SINR(s) for the one or more second candidate beams and the threshold-B; For instance, if a (differential) L1-RSRP/L1-SINR value computed with respect to or regarding or for a second candidate beam is x′ dBm, and the threshold-B is y dBm, a difference delta_diff_B′=|x′−y| dBm could be reported in the UEI report as a report content/quantity, and a corresponding one-bit sign indicator indicating either positive or negative of the difference could also be reported in the same UEI report. Or, the difference delta_diff_B′=(x′−y) and/or (y−x′) dBm could be reported in the UEI report as a report content/quantity. Optionally, the value of delta_diff_B′ could be quantized to a u-bit value with a v dB step size with respect to the threshold-B.
Component-2l: indicator(s) indicating presence or absent of Component-2a in the UEI report(s); e.g., the indicator(s) could be a one-bit indicator with ‘1’ (or ‘0’) indicating presence and ‘0’ (or ‘1’) indicating absence of Component-2a in the UEI report(s).
Component-2m: indicator(s) indicating presence or absent of Component-2b in the UEI report(s); e.g., the indicator(s) could be a one-bit indicator with ‘1’ (or ‘0’) indicating presence and ‘0’ (or ‘1’) indicating absence of Component-2b in the UEI report(s).
Component-2n: indicator(s) indicating presence or absent of Component-2c in the UEI report(s); e.g., the indicator(s) could be a one-bit indicator with ‘1’ (or ‘0’) indicating presence and ‘0’ (or ‘1’) indicating absence of Component-2c in the UEI report(s).
Component-2o: indicator(s) indicating presence or absent of Component-2d in the UEI report(s); e.g., the indicator(s) could be a one-bit indicator with ‘1’ (or ‘0’) indicating presence and ‘0’ (or ‘1’) indicating absence of Component-2d in the UEI report(s).
Component-2p: indicator(s) indicating presence or absence of Component-2j in the UEI report(s); e.g., the indicator(s) could be a one-bit indicator with ‘1’ (or ‘0’) indicating presence and ‘0’ (or ‘1’) indicating absence of Component-2j in the UEI report(s).
Component-2q: indicator(s) indicating presence or absence of Component-2k in the UEI report(s); e.g., the indicator(s) could be a one-bit indicator with ‘1’ (or ‘0’) indicating presence and ‘0’ (or ‘1’) indicating absence of Component-2k in the UEI report(s).

The value(s) of threshold-B, threshold-B′, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Nc>1. In another example, Nc≥1.

For a third event (denoted by Event-3), wherein the radio link or beam quality(s) of one or more current serving beams is below or less than or equal to a threshold-A (an instance for the third event), and the radio link or beam quality(s) of one or more candidate beams is beyond or greater than or equal to a threshold-B, a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s), and/or report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s). In this case, a/the UEI report, e.g., for the third event, could comprise one or more of the Component-1a to Component-1q as specified/defined herein in the present disclosure for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure, and one or more of the Component-2a to Component-2q for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure, and/or Component-3: indicator(s) indicating occurrence of the third event and/or an event index/ID associated/specific/corresponding to the third event.

For a fourth event (denoted by Event-4), wherein the radio link or beam quality(s) of one or more (or at least one) candidate beams is beyond or greater than the radio link or beam quality(s) of one or more current serving beams by a threshold-C (an instance for the fourth event), a/the UEI report could comprise report content(s)/quantity(s) including resource indicator(s) such as SSBRI(s)/CRI(s) and/or beam metric(s) such as L1-RSRP(s)/L1-SINR(s) for the current serving beam(s), and/or report content(s)/quantity(s) including resource indicator(s) such as SSBRI(s)/CRI(s) and/or beam metric(s) such as L1-RSRP(s)/L1-SINR(s) for the candidate beam(s), and/or information related to presence or absence of one or more of the report contents/quantities as described/specified herein in the present disclosure for the current serving beam(s), and/or information related to presence or absence of one or more of the report contents/quantities as described/specified herein in the present disclosure for the candidate beam(s), and/or quality metric(s) such as first difference(s) between the beam metric(s) such as L1-RSRP(s)/L1-SINR(s) for the current serving beam(s) and the beam metric(s) such as L1-RSRP(s)/L1-SINR(s) for the candidate beam(s), second difference(s) between the first difference(s) and the threshold-C. In this case, a/the UEI report, e.g., for the fourth event, could comprise one or more of the following components for one or more first current serving beams, wherein the one or more first current serving beams could comprise one or more (e.g., Ns) second current serving beams with their associated/corresponding radio link/beam quality(s) greater than or equal to or beyond a threshold-C′ or with their associated/corresponding radio link/beam quality(s) corresponding to the highest (or lowest) Ns radio link/beam quality(s) among the one or more first current serving beams as defined/specified herein in the present disclosure, and/or for one or more first candidate beams, wherein the one or more first candidate beams could comprise one or more (e.g., Nc) second candidate beams with their associated/corresponding radio link/beam quality(s) greater than or equal to or beyond a threshold-C″ or with their associated/corresponding radio link/beam quality(s) corresponding to the highest (or lowest) Nc radio link/beam quality(s) among the one or more first candidate beams as defined/specified herein in the present disclosure; in this case, as specified/described herein in the present disclosure, the radio link or beam quality(s) of the first candidate beam(s) is beyond or greater than the radio link or beam quality(s) of the first current serving beam(s) by the threshold-C.
Component-4a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-4b: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-4c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4a for the one or more first current serving beams; differential RSRP/SINR reporting could be applied to Component-4c according to those specified herein in the present disclosure.
Component-4d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4b for the one or more first candidate beams; differential RSRP/SINR reporting could be applied to Component-4c according to those specified herein in the present disclosure.
Component-4e: first difference(s) between the beam metric(s) such as L1-RSRP(s)/L1-SINR(s) for the one or more first current serving beams and the beam metric(s) such as L1-RSRP(s)/L1-SINR(s) for the one or more first candidate beams; For instance, if a (differential) L1-RSRP/L1-SINR value computed with respect to or regarding or for a first current serving beam is x1 dBm, and a (differential) L1-RSRP/L1-SINR value computed with respect to or regarding or for a first candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or, the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.
Component-4f: second difference(s) between the first difference(s) in Component-4e and the threshold-C; For instance, for a first difference delta_diff_C (or |delta_diff_C|) specified/defined or obtained in Component-4e and if the threshold-C is z dBm, a second difference delta_diff_C′=|delta_diff_C−z| dBm could be reported in the UEI report as a report content/quantity, and a corresponding one-bit sign indicator indicating either positive or negative of the second difference could also be reported in the same UEI report. Or, the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4g: indicator(s) or bitmap(s) indicating the one or more first current serving beams—e.g., out of the current serving beams
Component-4h: indicator(s) or bitmap(s) indicating the one or more first candidate beams—e.g., out of the candidate beams.
Component-4i: a number of the one or more first current serving beams in the UEI report(s)
Component-4j: a number of the one or more first candidate beams in the UEI report(s)
Component-4k: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-4l: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-4m: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4k for the one or more second current serving beams; differential RSRP/SINR reporting could be applied to Component-4m according to those specified herein in the present disclosure.
Component-4n: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4l for the one or more second candidate beams; differential RSRP/SINR reporting could be applied to Component-4n according to those specified herein in the present disclosure.
Component-4o: first difference(s) between the beam metric(s) such as L1-RSRP(s)/L1-SINR(s) for the one or more second current serving beams and the beam metric(s) such as L1-RSRP(s)/L1-SINR(s) for the one or more second candidate beams; For instance, if a (differential) L1-RSRP/L1-SINR value computed with respect to or regarding or for a second current serving beam is x1 dBm, and a (differential) L1-RSRP/L1-SINR value computed with respect to or regarding or for a second candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or, the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.
Component-4p: second difference(s) between the first difference(s) in Component-4o and the threshold-C; For instance, for a first difference delta_diff_C (or |delta_diff_C|) specified/defined or obtained in Component-4o and if the threshold-C is z dBm, a second difference delta_diff_C′=|delta_diff_C−z| dBm could be reported in the UEI report as a report content/quantity, and a corresponding one-bit sign indicator indicating either positive or negative of the second difference could also be reported in the same UEI report. Or, the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4q: indicator(s) or bitmap(s) indicating the one or more second current serving beams—e.g., out of the current serving beams or out of the first current serving beam(s)
Component-4r: indicator(s) or bitmap(s) indicating the one or more second candidate beams—e.g., out of the candidate beams or out of the first candidate beam(s).
Component-4s: a number of the one or more second current serving beams in the UEI report(s)
Component-4t: a number of the one or more second candidate beams in the UEI report(s)
Component-4u: indicator(s) indicating occurrence of the fourth event and/or an event index/ID associated/specific/corresponding to the fourth event
Component-5a: indicator(s) indicating presence or absent of Component-4a in the UEI report(s); e.g., the indicator(s) could be a one-bit indicator with ‘1’ (or ‘0’) indicating presence and ‘0’ (or ‘1’) indicating absence of Component-4a in the UEI report(s).
Component-5b: indicator(s) indicating presence or absent of Component-4b in the UEI report(s); e.g., the indicator(s) could be a one-bit indicator with ‘1’ (or ‘0’) indicating presence and ‘0’ (or ‘1’) indicating absence of Component-4b in the UEI report(s).
Component-5c: indicator(s) indicating presence or absent of Component-4c in the UEI report(s); e.g., the indicator(s) could be a one-bit indicator with ‘1’ (or ‘0’) indicating presence and ‘0’ (or ‘1’) indicating absence of Component-4c in the UEI report(s).
Component-5d: indicator(s) indicating presence or absent of Component-4d in the UEI report(s); e.g., the indicator(s) could be a one-bit indicator with ‘1’ (or ‘0’) indicating presence and ‘0’ (or ‘1’) indicating absence of Component-4d in the UEI report(s).
Component-5e: indicator(s) indicating presence or absence of Component-4e in the UEI report(s); e.g., the indicator(s) could be a one-bit indicator with ‘1’ (or ‘0’) indicating presence and ‘0’ (or ‘1’) indicating absence of Component-4e in the UEI report(s).
Component-5f: indicator(s) indicating presence or absence of Component-4f in the UEI report(s); e.g., the indicator(s) could be a one-bit indicator with ‘1’ (or ‘0’) indicating presence and ‘0’ (or ‘1’) indicating absence of Component-4f in the UEI report(s).
Component-5g: indicator(s) indicating presence or absent of Component-4k in the UEI report(s); e.g., the indicator(s) could be a one-bit indicator with ‘1’ (or ‘0’) indicating presence and ‘0’ (or ‘1’) indicating absence of Component-4k in the UEI report(s).
Component-5h: indicator(s) indicating presence or absent of Component-4l in the UEI report(s); e.g., the indicator(s) could be a one-bit indicator with ‘1’ (or ‘0’) indicating presence and ‘0’ (or ‘1’) indicating absence of Component-4l in the UEI report(s).
Component-5i: indicator(s) indicating presence or absent of Component-4m in the UEI report(s); e.g., the indicator(s) could be a one-bit indicator with ‘1’ (or ‘0’) indicating presence and ‘0’ (or ‘1’) indicating absence of Component-4m in the UEI report(s).
Component-5j: indicator(s) indicating presence or absent of Component-4n in the UEI report(s); e.g., the indicator(s) could be a one-bit indicator with ‘1’ (or ‘0’) indicating presence and ‘0’ (or ‘1’) indicating absence of Component-4n in the UEI report(s).
Component-5k: indicator(s) indicating presence or absence of Component-4o in the UEI report(s); e.g., the indicator(s) could be a one-bit indicator with ‘1’ (or ‘0’) indicating presence and ‘0’ (or ‘1’) indicating absence of Component-4o in the UEI report(s).
Component-5l: indicator(s) indicating presence or absence of Component-4p in the UEI report(s); e.g., the indicator(s) could be a one-bit indicator with ‘1’ (or ‘0’) indicating presence and ‘0’ (or ‘1’) indicating absence of Component-4p in the UEI report(s).

The value(s) of threshold-C, threshold-C′, threshold-C″, Ns, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. In one example, Nc>1 and/or Ns>1. In another example, Nc≥1 and/or Ns≥1.

For each (or one or more) of the first, second, third and fourth events, and/or for a UE (e.g., the UE 116) to declare each (or one or more) of the first, second, third and fourth events, and/or for a UE to formulate, construct, transmit and/or send the UEI report(s) with the report content(s)/quantity(s) corresponding to each (or one or more) of the first, second, third and fourth events according to or following those specified herein in the present disclosure, and/or for a UE to use/apply each (or one or more) of the first, second, third and fourth events for triggering or initiating the UEI reporting according to or following those specified herein in the present disclosure, the corresponding MAC entity could or shall for each Serving Cell configured for UEI reporting according to those specified herein in the present disclosure:
1> to initiate or trigger a UEI reporting based on or according to detection or declaration of one or each of the first, second, third and fourth events, individually:
   2> if an indication for an instance for an event (e.g., the first, second, third or fourth event) has been received from lower layers:
      3> start or restart the firstEventInstanceDetectionTimer, secondEventInstanceDetectionTimer, thirdEventInstanceDetectionTimer or fourthEventInstanceDetectionTimer (higher layer configured respectively for the first, second, third or fourth event-when/if applicable)
      3> increment firstEvent_COUNTER, secondEvent_COUNTER, thirdEvent_COUNTER or fourthEvent_COUNTER (higher layer configured respectively for the first, second, third or fourth event-when/if applicable) by 1;
      3> if firstEvent_COUNTER>=firstEventInstanceMaxCount, secondEvent_COUNTER>=secondEventInstanceMaxCount, thirdEvent_COUNTER>=thirdEventInstanceMaxCount or fourthEvent_COUNTER>=fourthEventInstanceMaxCount (respectively for the first, second, third or fourth event-when/if applicable), wherein the firstEventInstanceMaxCount, secondEventInstanceMaxCount, thirdEventInstanceMaxCount or fourthEventInstanceMaxCount is higher layer configured respectively for the first, second, third or fourth event-when/if applicable:
         4> trigger a UEI (beam) reporting specific to the first, second, third or fourth event-when/if applicable—for this Serving Cell, wherein the report content(s)/quantity(s) in the UEI report(s) is specific to the first, second, third or fourth event-when/if applicable-according to or following those specified herein in the present disclosure.
   2> if the firstEventInstanceDetectionTimer, secondEventInstance DetectionTimer, thirdEventInstance DetectionTimer or fourthEventInstance DetectionTimer (respectively for the first, second, third or fourth event-when/if applicable) expires; or
   2> if the firstEventInstanceDetectionTimer, secondEventInstance DetectionTimer, thirdEventInstance DetectionTimer or fourthEventInstance DetectionTimer (respectively for the first, second, third or fourth event-when/if applicable), firstEvent_COUNTER, secondEvent_COUNTER, thirdEvent_COUNTER or fourthEvent_COUNTER (respectively for the first, second, third or fourth event-when/if applicable), or any of the reference signals used for UEI reporting—e.g., including that/those specific to/for the current serving beam(s) and/or the candidate beam(s) as specified or defined herein in the present disclosure specific to/for the first, second, third or fourth event—is reconfigured by upper layers associated with this Serving Cell; or
   2> if the reference signal(s) associated with this Serving Cell used for detection/declaration/indication for the first, second, third or fourth event as specified/defined herein in the present disclosure is changed and/or reconfigured by upper layers associated with this Serving Cell:
      3> set firstEvent_COUNTER, secondEvent_COUNTER, thirdEvent_COUNTER or fourthEvent_COUNTER (respectively for the first, second, third or fourth event-when/if applicable) to 0; and/or
      3> stop the ueiReportingTimer, if configured; and/or
      3> view the UE-initiated (UEI) reporting procedure triggered or initiated with respect to the first, second, third or fourth event successfully completed, and/or cancel the UEI report(s) triggered or initiated with respect to the first, second, third or fourth event for this Serving Cell.

The described or specified MAC entity and the corresponding operation(s)/procedure(s) herein are for triggering or initiating one or more UEI report(s) according to or based on detection or declaration of one of the first, second, third and fourth events according to or following those specified herein in the present disclosure. To trigger or initiate a UEI reporting based on or according to detection or declaration of more than one or multiple events—e.g., the third and fourth events-jointly or simultaneously, the corresponding MAC entity—e.g., for the third and fourth events-could or shall for each Serving Cell configured for UEI reporting according to those specified herein in the present disclosure:
1> to initiate or trigger a UEI reporting based on or according to detection or declaration of the third and fourth events, jointly or simultaneously:
   2> if an indication for an instance for the third event has been received from lower layers, and/or if an indication for an instance for the fourth event has been received from lower layers:
      3> start or restart the thirdEventInstanceDetectionTimer and/or fourthEventInstanceDetectionTimer (higher layer configured for the third and/or fourth event(s)—when/if applicable)
      3> increment thirdEvent_COUNTER and/or fourthEvent_COUNTER (higher layer configured for the third and/or fourth event(s)—when/if applicable) by 1;
      3> if both thirdEvent_COUNTER>=thirdEventInstanceMaxCount and fourthEvent_COUNTER>=fourthEventInstanceMaxCount (for the third and fourth events-when/if applicable), wherein the thirdEventInstanceMaxCount and fourthEventInstanceMaxCount are higher layer configured respectively for the third and fourth events-when/if applicable:
         4> trigger a UEI (beam) reporting specific to the third and fourth events for this Serving Cell, wherein the report content(s)/quantity(s) in the UEI report(s) is specific to the third and fourth events-when/if applicable-according to or following those specified herein in the present disclosure.
   2> if the thirdEventInstance DetectionTimer and/or fourthEventInstanceDetectionTimer (respectively for the third and/or fourth event(s)—when/if applicable) expires; or
   2> if the thirdEventInstance DetectionTimer and/or fourthEventInstanceDetectionTimer (respectively for the third and/or fourth event(s)—when/if applicable), thirdEvent_COUNTER and/or fourthEvent_COUNTER (respectively for the third and/or fourth event(s)—when/if applicable), or any of the reference signals used for UEI reporting—e.g., including that/those specific to/for the current serving beam(s) and/or the candidate beam(s) as specified or defined herein in the present disclosure for the third and/or fourth event(s)—is reconfigured by upper layers associated with this Serving Cell; or
   2> if the reference signal(s) associated with this Serving Cell used for detection/declaration/indication for the third and/or fourth event(s) as specified/defined herein in the present disclosure is changed and/or reconfigured by upper layers associated with this Serving Cell:
      3> set thirdEvent_COUNTER and/or fourthEvent_COUNTER (respectively for the third and/or fourth event(s)—when/if applicable) to 0; and/or
      3> stop the ueiReportingTimer, if configured; and/or
      3> view the UE-initiated (UEI) reporting procedure triggered or initiated with respect to both the third and fourth events successfully completed, and/or cancel the UEI report(s) triggered or initiated with respect to the third and fourth events for this Serving Cell.

The described/specified MAC entity(s) and the corresponding operation(s)/procedure(s) herein could be applied or extended to when/if more than two events could be configured and/or enabled by the network and/or applied or used by the UE for initiating or triggering the UEI reporting.

As specified/discussed herein in the present disclosure, a UE could indicate or send or transmit to the network a capability signaling indicating whether or not the UE can support one or more of the events as specified herein in the present disclosure. For instance, the corresponding capability or capability signaling could comprise one or more of the following components—i.e., if the corresponding capability or capability signaling comprises {Event-1, Event-4}, the UE could indicate or send or transmit to the network that they could support or could be capable of supporting the Event-1 and Event-4 in the present disclosure:
{Event-1}; {Event-2}; {Event-3}; {Event-4}; {Event-1, Event-2}; {Event-1, Event-3}; {Event-1, Event-4}; {Event-2, Event-3}; {Event-2, Event-4}; {Event-3, Event-4}; {Event-1, Event-2, Event-3}; {Event-1, Event-2, Event-4}; {Event-1, Event-3, Event-4}; {Event-2, Event-3, Event-4}; and {Event-1, Event-2, Event-3, Event-4}.

Furthermore, UEs that could or would support the UE-initiated or event-driven reporting should support or indicate their support of one or more of the events-such as Event-4; i.e., the one or more of the events-such as Event-4 in the present disclosure-could be specified or regarded as basic UE feature(s). The UE could be indicated, provided or configured by the network, e.g., via higher layer RRC signaling(s)/parameter(s) and/or MAC CE command(s) and/or dynamic DCI based L1 signaling(s) based on a corresponding UE's capability or capability signaling as discussed herein, that one or more (e.g., only one) of the events (e.g., Event-1 or Event-4) can be enabled. For instance, a higher layer parameter eventType could be configured or provided or indicated in the higher layer parameter(s) CSI-ReportConfig, CSI-ResourceConfig, and/or UE-ReportConfig, UEI-ResourceConfig, etc. that provides or configures information or settings for the UE-initiated or event-driven beam reporting. For instance, when/if the eventType is set to ‘Event-1’ or ‘one’ or ‘1’ or ‘first’ or ‘enabled’ (or ‘disabled’) or 1 (or 0), the Event-1 as specified/described herein in the present disclosure is enabled; and when/if the eventType is set to ‘Event-4’ or ‘four’ or ‘4’ or ‘fourth’ or ‘two’ or ‘2’ or ‘second’ or ‘disabled’ (or ‘enabled’) or 0 (or 1), the Event-4 as specified/described herein in the present disclosure is enabled.

As specified herein in the present disclosure, to declare an event and to trigger the corresponding (beam) reporting, a UE would need to first determine or identify, for a given counting instance, whether or not an instance of the event is detected. When/if a UE has detected an instance for an event (and therefore for a counting instance corresponding/associated to the detection of the instance of the event)—i.e., the UE has detected or determined or identified that the condition(s) for the event has been satisfied or achieved—the UE (e.g., higher layer(s) of the UE) could increase the number of count(s)—e.g., in the event counter specific or associated to the event as specified/defined herein in the present disclosure—for declaring the event by 1. Here, a counting instance could also correspond or could be associated to a measurement instance such that for a given event (e.g., Event-4) and a counting instance, a UE could obtain, determine or identify one or more measurement quantities including, e.g., one or more candidate/new beams (or candidate/new beam RSs or resource indicators such as SSBRIs/CRIs corresponding to the obtained/determined/identified candidate/new beam RSs) as specified/defined herein in the present disclosure and/or the corresponding beam metrics including L1-RSRPs/L1-SINRs. To trigger a (beam) report based on declaration/detection of an event, the UE (or the higher layer(s) of the UE) could determine or identify whether a/the maximum or a/the minimum number of counts—e.g., in the event counter specific or associated to the event as specified/defined herein in the present disclosure—has been achieved before a corresponding event instance detection timer expires following or according to those specified herein in the present disclosure based on or according to or following one or more of:
In one example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1. Furthermore, when/if the UE has identified, determined or detected a second (or current) instance of the event, the UE (e.g., the higher layer(s) of the UE) could increase the number of count(s), e.g., in the event counter specific/associated to the event, by 1. For this design example, the UE could determine or identify first/second measurement quantity(s) as specified/defined herein in the present disclosure corresponding/associated to a first/second counting/measurement instance corresponding/associated to the detection of the first (or previous)/second (or current) instance of the event; furthermore, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1. Furthermore, when/if the UE has identified, determined or detected a second (or current) instance of the event, the UE (e.g., the higher layer(s) of the UE) could increase the number of count(s), e.g., in the event counter specific/associated to the event, by 1. In this design example, a first counting instance (or a corresponding/associated measurement instance as specified/defined herein in the present disclosure) and a second counting instance (or a corresponding/associated measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the UE could determine or identify first/second measurement quantity(s) as specified/defined herein in the present disclosure corresponding/associated to a first/second counting/measurement instance corresponding/associated to the detection of the first (or previous)/second (or current) instance of the event; furthermore, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance-denoted by a first measurement instance-corresponding/associated to the first counting instance and the measurement instance-denoted by a second measurement instance-corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance-denoted by a first measurement instance-corresponding/associated to the first counting instance and the measurement instance-denoted by a second measurement instance-corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if (e.g., each of) the second measurement quantity(s) is identical to or the same as (e.g., each of) the first measurement quantity(s), the UE (e.g., the higher layer(s) of the UE) could increase the number of count(s), e.g., in the event counter specific/associated to the event, by 1. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if (e.g., each of) the second measurement quantity(s) is identical to or the same as (e.g., each of) the first measurement quantity(s), the UE (e.g., the higher layer(s) of the UE) could increase the number of count(s), e.g., in the event counter specific/associated to the event, by 1. In this design example, the first counting instance (or the corresponding/associated first measurement instance as specified/defined herein in the present disclosure) and the second counting instance (or the corresponding/associated second measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance-denoted by a first measurement instance-corresponding/associated to the first counting instance and the measurement instance-denoted by a second measurement instance-corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance-denoted by a first measurement instance-corresponding/associated to the first counting instance and the measurement instance-denoted by a second measurement instance-corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE (e.g., the UE 116) has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if at least one of the second measurement quantity(s) is identical to or the same as at least one of the first measurement quantity(s), the UE (e.g., the higher layer(s) of the UE) could increase the number of count(s), e.g., in the event counter specific/associated to the event, by 1. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if at least one of the second measurement quantity(s) is identical to or the same as at least one of the first measurement quantity(s), the UE (e.g., the higher layer(s) of the UE) could increase the number of count(s), e.g., in the event counter specific/associated to the event, by 1. In this design example, the first counting instance (or the corresponding/associated first measurement instance as specified/defined herein in the present disclosure) and the second counting instance (or the corresponding/associated second measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance-denoted by a first measurement instance-corresponding/associated to the first counting instance and the measurement instance-denoted by a second measurement instance-corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance-denoted by a first measurement instance-corresponding/associated to the first counting instance and the measurement instance-denoted by a second measurement instance-corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance-denoted by a first measurement instance-corresponding/associated to the first counting instance, the measurement instance-denoted by a second measurement instance-corresponding/associated to the second counting instance, . . . , and the measurement instance-denoted by a K-th measurement instance-corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance-denoted by a first measurement instance-corresponding/associated to the first counting instance, the measurement instance-denoted by a second measurement instance-corresponding/associated to the second counting instance, . . . , and the measurement instance-denoted by a K-th measurement instance-corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance-corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance-denoted by a first measurement instance-corresponding/associated to the first counting instance, the measurement instance-denoted by a second measurement instance-corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE (e.g., the UE 116) has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance-denoted by a first measurement instance-corresponding/associated to the first counting instance, the measurement instance-denoted by a second measurement instance-corresponding/associated to the second counting instance, . . . , and the measurement instance-denoted by a K-th measurement instance-corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event (e.g., Event-4), when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance-denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance-denoted by a first measurement instance-corresponding/associated to the first counting instance, the measurement instance-denoted by a second measurement instance-corresponding/associated to the second counting instance, . . . , and the measurement instance-denoted by a K-th measurement instance-corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.

As specified herein in the present disclosure, for a given event, a measurement quantity (and therefore, a corresponding candidate report content/quantity as defined/specified herein in the present disclosure) could correspond to a report content/quantity as specified herein in the present disclosure for the event. For instance, for the Event-4 as specified herein in the present disclosure, a measurement quantity (and therefore, a corresponding candidate report content/quantity as defined/specified herein in the present disclosure) could correspond to an identified candidate/new beam that satisfies the Event-4 condition, an identified candidate/new beam RS/RS resource/RS resource index (or the corresponding SSBRI/CRI) that satisfies the Event-4 condition, the current serving beam or the current serving beam RS/RS resource/RS resource index (or the corresponding SSBRI/CRI) that satisfies the Event-4 condition, a (measured/differential) L1-RSRP/L1-SINR value associated/specific to an identified candidate/new beam or candidate/new beam RS/RS resource/RS resource index (or the corresponding SSBRI/CRI) that satisfies the Event-4 condition, and a (measured/differential) L1-RSRP/L1-SINR value associated/specific to the current serving beam or the current serving beam RS/RS resource/RS resource index (or the corresponding SSBRI/CRI) that satisfies the Event-4 condition. Or, the first, second, . . . , and/or K-th measurement quantity(s) as defined/specified herein in the present disclosure (and therefore, the corresponding first, second, . . . , and/or K-th candidate report content(s)/quantity(s) as defined/specified herein in the present disclosure) could correspond to or comprise one or more of: one or more report contents/quantities as specified herein in the present disclosure for the event. For instance, for the Event-4 as specified herein in the present disclosure, the first, second, . . . , and/or K-th measurement quantity(s) as defined/specified herein in the present disclosure (and therefore, the corresponding first, second, . . . , and/or K-th candidate report content(s)/quantity(s) as defined/specified herein in the present disclosure) could correspond to or comprise one or more of: one or more identified candidate/new beams that satisfy the Event-4 condition, one or more identified candidate/new beam RSs/RS resources/RS resource indexes (or the corresponding SSBRIs/CRIs) that satisfy the Event-4 condition, the current serving beam or the current serving beam RS/RS resource/RS resource index (or the corresponding SSBRI/CRI) that satisfies the Event-4 condition, one or more (measured/differential) L1-RSRP/L1-SINR values associated/specific to the one or more identified candidate/new beams or candidate/new beam RSs/RS resources/RS resource indexes (or the corresponding SSBRIs/CRIs) that satisfy the Event-4 condition, and a (measured/differential) L1-RSRP/L1-SINR value associated/specific to the current serving beam or the current serving beam RS/RS resource/RS resource index (or the corresponding SSBRI/CRI) that satisfies the Event-4 condition. Across different measurement instances as described/specified herein in the present disclosure, the type of the measurement RS(s) for the candidate/new beam(s) could be the same/identical, e.g., CSI-RS(s) or SSB(s).

After the UE has declared an event, the UE could trigger or initiate a (beam) reporting following those specified/described herein in the present disclosure, and transmit or send to the network a UEI (beam) report comprising one or more report contents/quantities (including resource indicator(s) such as SSBRI(s)/CRI(s) and the corresponding beam metric(s) such as L1-RSRP(s)/L1-SINR(s)) determined according to one or more of:
In one example, the one or more report contents/quantities in the UEI (beam) report could comprise the candidate report content(s)/quantity(s) as defined/specified herein in the present disclosure obtained, identified or determined by the UE during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   The first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise one or more of the first candidate report content(s)/quantity(s), one or more of the second candidate report content(s)/quantity(s), . . . , and one or more of the K-th candidate report content(s)/quantity(s) that are the same as/identical to each other as defined/specified herein in the present disclosure, wherein the first, second and K-th candidate report content(s)/quantity(s) are obtained, identified or determined by the UE during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise common, identical or same components of the first candidate report content(s)/quantity(s), the second candidate report content(s)/quantity(s), . . . , and the K-th candidate report content(s)/quantity(s) as defined/specified herein in the present disclosure obtained, identified or determined by the UE during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise one or more (e.g., M≥1) of the first candidate report content(s)/quantity(s), one or more (e.g., M≥1) of the second candidate report content(s)/quantity(s), . . . , and one or more (e.g., M≥1) of the K-th candidate report content(s)/quantity(s) that are the same as/identical to each other as defined/specified herein in the present disclosure, wherein the first, second and K-th candidate report content(s)/quantity(s) are obtained, identified or determined by the UE during the process of event declaration or declaring an event according to or following those specified herein in the present disclosure, and M could be greater than (or less than) or equal to a threshold value (denoted by Mmin). Here, the threshold value or value of Mmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise common, identical or same (e.g., the common, identical or same M≥1) components of the first candidate report content(s)/quantity(s), the second candidate report content(s)/quantity(s), . . . , and the K-th candidate report content(s)/quantity(s) as defined/specified herein in the present disclosure obtained, identified or determined by the UE during the process of event declaration or declaring an event according to or following those specified herein in the present disclosure, and M could be greater than (or less than) or equal to a threshold value (denoted by Mmin). Here, the threshold value or value of Mmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise common, identical or same components of one or more of the first candidate report content(s)/quantity(s), the second candidate report content(s)/quantity(s), . . . , and the K-th candidate report content(s)/quantity(s) as defined/specified herein in the present disclosure obtained, identified or determined by the UE (e.g., the UE 116) during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise common, identical or same components of one or more (e.g., Q≥1) of the first candidate report content(s)/quantity(s), the second candidate report content(s)/quantity(s), . . . , and the K-th candidate report content(s)/quantity(s) as defined/specified herein in the present disclosure obtained, identified or determined by the UE during the process of event declaration or declaring an event according to or following those specified herein in the present disclosure, and Q could be greater than (or less than) or equal to a threshold value (denoted by Qmin). Here, the threshold value or value of Qmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could only comprise one or more of the first candidate report content(s)/quantity(s) obtained, identified or determined by the UE at the very beginning during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could only comprise one or more of the K-th candidate report content(s)/quantity(s) obtained, identified or determined by the UE at the very last/end during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other

A UE could indicate or send or transmit to the network a capability signaling indicating whether or not the UE can or would like to support one or more of the described/specified processes and/or procedures herein of declaring an event or event declaration (including the event counter—e.g., with a candidate value of maximum number of counts as zero, event instance detection timer—e.g., with a candidate value of zero, according to one or more examples described herein). Furthermore, UEs that could or would support the UE-initiated or event-driven reporting should or could support or indicate their support of a candidate value of zero of the maximum number of counts for the event counter(s) and/or a candidate value of 0 of the event instance detection timer(s); i.e., supporting of a candidate value of zero of the maximum number of counts for the event counter and/or a candidate value of 0 of the event instance detection timer(s) could be specified or regarded as basic UE feature(s). The UE could be indicated, provided or configured by the network, e.g., via higher layer RRC signaling(s)/parameter(s) and/or MAC CE command(s) and/or dynamic DCI based L1 signaling(s) based on a corresponding UE's capability or capability signaling as discussed herein, that one or more of the described/specified processes or procedures herein of declaring an event or event declaration (including the event counter, event instance detection timer, according to one or more examples described herein) could be enabled. For instance, a higher layer parameter eventDeclaration could be configured or provided or indicated in the higher layer parameter(s) CSI-ReportConfig, CSI-ResourceConfig, and/or UE-ReportConfig, UEI-ResourceConfig, etc. that provides or configures information or settings for the UE-initiated or event-driven beam reporting. For instance, when/if the eventDeclaration is present/configured/provided and/or set to ‘on’ or ‘enabled’ or 1, the event counter(s), the event instance detection timer(s), etc. and the corresponding MAC procedures as specified/described herein could be enabled for the UE for declaring the event(s). Otherwise, i.e., when/if the eventDeclaration is set to ‘off’ or ‘disabled’ or 0 or absent or not present/configured/provided, the event counter(s), the event instance detection timer(s), etc. and the corresponding MAC procedures as specified/described herein could be disabled or not used/applied by the UE for declaring the event(s).

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

The RS(s) or RS resource(s) or RS resource index(es) of/for a current serving beam-denoted by current serving beam RS(s) or RS resource(s) or RS resource index(es)—could be identified or determined according to one or more of:
(implicit determination example-1): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a tracking reference signal (TRS) is also a type of CSI-RS.
(implicit determination example-2): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-1): a set \vec{s}₀ of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set 5% of (periodic) CSI-RS resource configuration indexes could be provided in higher layer parameter(s) CSI-ReportConfig, CSI-ResourceConfig, nzp-CSI-RS-ResourceSet and/or higher layer parameter(s) UEI-ReportConfig, UEI-ResourceConfig and/or etc. dedicated/configured for the UEI reporting as specified herein in the present disclosure.
(explicit configuration example-2): a set s̅₀ of SS/PBCH block indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set \vec{s}₀ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure.

In one example, when/if the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to ‘on’), the UE could follow those specified in the implicit determination example-1 in the present disclosure to determine or identify the current serving beam RS(s)/RS resource(s)/RS resource index(es). In another example, when/if the one or more RSs/RS resources/RS resource indexes provided in/by the indicated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-1 in the present disclosure to determine or identify the current serving beam RS(s)/RS resource(s)/RS resource index(es), but instead, the UE could expect to be provided or configured or indicated by the network a/the set 5% of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the explicit configuration example-1 in the present disclosure. Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting according to (or that has the same RS(s) or RS resource(s) or RS resource index(es) as to)
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Candidate RS(s) or RS resource(s) or RS resource index(es)—denoted by candidate candidate/new beam RS(s) or RS resource(s) or RS resource index(es)—for determining the RS(s) or RS resource(s) or RS resource index(es) for actual measurement of/for a candidate/new beam-denoted by actual candidate/new beam RS(s) or RS resource(s) or RS resource index(es)—could be identified or determined according to one or more of:
(explicit configuration example-A): a set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes could be provided in higher layer parameter(s) CSI-ReportConfig, CSI-ResourceConfig, nzp-CSI-RS-ResourceSet, and/or higher layer parameter(s) UEI-ReportConfig, UEI-ResourceConfig and/or etc. dedicated/configured for the UEI reporting as specified herein in the present disclosure.
(explicit configuration example-B): a set s̅₁ of SS/PBCH block indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure.
(implicit determination example-A): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-B): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(implicit determination example-C): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-D): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In one example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to ‘on’), the UE (e.g., the UE 116) could follow those specified in the implicit determination example-A/C in the present disclosure to determine or identify the candidate/actual candidate/new beam RS(s)/RS resource(s)/RS resource index(es). In another example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking reference signal(s)—e.g., CSI-RS(s) configured with trs-Info, the UE may not follow those specified in the implicit determination example-A/C in the present disclosure to determine or identify the candidate/actual candidate/new beam RS(s)/RS resource(s)/RS resource index(es), but instead, the UE could expect to be provided or configured or indicated by the network (e.g., the network 130) a/the set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the explicit configuration example-A in the present disclosure.

Furthermore, the UE could identify or determine a subset of the candidate RS(s) or RS resource(s) or RS resource index(es) configured following those specified/described in the explicit configuration example-A/B and/or determined following those specified/described in the implicit determination example-A, the implicit determination example-B, the implicit determination example-C and/or the implicit determination example-D as the RS(s) or RS resource(s) or RS resource index(es) for the actual measurement for/of one or more candidate/new beams.
In one example, the UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.
   For example, the one or more indicators could be or could correspond to a set of RS resource index(es)—e.g., a set of CSI-RS resource configuration index(es) and/or SSB index(es). For this design example, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) could provide or indicate or contain or include or comprise one or more indexes each belonging to {1, . . . , K}. Specifically, when/if the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
   For another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when/if an entry/bit position of the bitmap is set to ‘1’ (or ‘0’), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap associated/corresponding to the RS index #1, RS index #2 and RS index #K are set to ‘1’s while the entry(s)/bit position(s) in the bitmap associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap that are set to ‘1’s could be used/applied as the RS(s) or RS resource(s) for the actual measurement for/of the one or more candidate/new beams.
   For another example, the one or more indicators could be or could correspond to one or more 1-bit indicators each corresponding/associated to a candidate RS/RS resource/RS resource index or one of the candidate RS(s) or RS resource(s) or RS resource index(es). In this case, when/if a 1-bit indicator is set to ‘1’ (or ‘0’), the UE could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators associated/corresponding to the RS index #1, RS index #2 and RS index #K are set to ‘1’s while the 1-bit indicators associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators that are set to ‘1’s could be used/applied as the RS(s) or RS resource(s) for the actual measurement for/of the one or more candidate/new beams.
In another example, the UE could determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams according to one or more of the followings, based on e.g. (1) fixed rule(s) in system specification(s) or per RRC (re) configuration, (ii) network's configuration(s) or indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection.
   For example, the first (or last) L≥1 candidate RS(s) or RS resource(s) or RS resource index(es) or the L≥1 candidate RS(s) or RS resource(s) with the lowest (or highest) resource index(es)—among the K configured/determined candidate RS(s) or RS resource(s) or RS resource index(es) with L≤K—could be used/applied as the RS(s) or RS resource(s) or RS resource index(es) for the actual measurement for/of the one or more candidate/new beams. Optionally, the first (or last) half of the K configured/determined candidate RS(s) or RS resource(s) or RS resource index(es) or the half of the K configured/determined candidate RS(s) or RS resource(s) with the lowest (or highest) resource index(es) could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #1 and RS index #2 in the set s̅₁ (i.e., the first half) could be used/applied as the RS(s) or RS resource(s) for the actual measurement for/of the one or more candidate/new beams.
   For another example, the even-ordered or even-numbered or even-indexed candidate RS(s) or RS resource(s) or RS resource index(es) or the candidate RS(s) or RS resource(s) with even-valued resource index(es)—among the K configured/determined candidate RS(s) or RS resource(s) or RS resource index(es)—could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #2 and RS index #4 (even-valued RS resource indexes) in the set s̅₁ could be used/applied as the RS(s) or RS resource(s) for the actual measurement for/of the one or more candidate/new beams.
   For another example, the odd-ordered or odd-numbered or odd-indexed candidate RS(s) or RS resource(s) or RS resource index(es) or the candidate RS(s) or RS resource(s) with odd-valued resource index(es)—among the K configured/determined candidate RS(s) or RS resource(s) or RS resource index(es)—could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #1 and RS index #3 (odd-valued RS resource indexes) in the set s̅₁ could be used/applied as the RS(s) or RS resource(s) for the actual measurement for/of the one or more candidate/new beams.
In another example, the UE could indicate or transmit or send to the network, e.g., by/in part of a/the UEI beam report, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.
   For example, the one or more indicators could be or could correspond to a set of RS resource index(es)—e.g., a set of CSI-RS resource configuration index(es) and/or SSB index(es). For this design example, each of the RS resource index(es) in the set could correspond/point to or represent a candidate RS/RS resource/RS resource index or one of the candidate RS(s) or RS resource(s) or RS resource index(es). In this case, the UE could determine/identify and/or indicate to the network that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) could provide or indicate or contain or include or comprise one or more indexes each belonging to {1, . . . , K}. Specifically, when/if the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
   For another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when/if an entry/bit position of the bitmap is set to ‘1’ (or ‘0’), the UE could determine/identify and/or indicate to the network that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap associated/corresponding to the RS index #1, RS index #2 and RS index #K are set to ‘1’s while the entry(s)/bit position(s) in the bitmap associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap that are set to ‘1’s could be used/applied as the RS(s) or RS resource(s) for the actual measurement for/of the one or more candidate/new beams.
   For another example, the one or more indicators could be or could correspond to one or more 1-bit indicators each corresponding/associated to a candidate RS/RS resource/RS resource index or one of the candidate RS(s) or RS resource(s) or RS resource index(es). In this case, when/if a 1-bit indicator is set to ‘1’ (or ‘0’), the UE could determine/identify and/or indicate to the network that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators associated/corresponding to the RS index #1, RS index #2 and RS index #K are set to ‘1’s while the 1-bit indicators associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators that are set to ‘1’s could be used/applied as the RS(s) or RS resource(s) for the actual measurement for/of the one or more candidate/new beams.

As specified herein in the present disclosure, a UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams. In particular, the one or more indicators as defined/specified herein in the present disclosure could be provided or indicated or contained or comprised or included or configured in a/the higher layer parameter TCI-State or TCI-UL-State that configures or provides the indicated TCI state.
In one example, the one or more indicators could be or could correspond to a set of RS resource index(es)—e.g., a set of CSI-RS resource configuration index(es) and/or SSB index(es). As discussed/specified herein in the present disclosure, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) provided, indicated, contained, comprised, configured or included in a/the higher layer parameter TCI-State or TCI-UL-State that configures or provides the indicated TCI state could provide or indicate or contain or include or comprise one or more indexes each belonging to {1, . . . , K}. Specifically, when/if the RS resource indexes in the set provided, indicated, contained, comprised, configured or included in a/the higher layer parameter TCI-State or TCI-UL-State that configures or provides the indicated TCI state correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
In another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). As discussed/specified herein in the present disclosure, when/if an entry/bit position of the bitmap is set to ‘1’ (or ‘0’), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap provided, indicated, contained, comprised, configured or indicated in a/the higher layer parameter TCI-State or TCI-UL-State that configures or provides the indicated TCI state associated/corresponding to the RS index #1, RS index #2 and RS index #K are set to ‘1’s while the entry(s)/bit position(s) in the bitmap provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap provided, indicated, contained, comprised, configured or indicated in a/the higher layer parameter TCI-State or TCI-UL-State that configures or provides the indicated TCI state that are set to ‘1’s could be used/applied as the RS(s) or RS resource(s) for the actual measurement for/of the one or more candidate/new beams.
In another example, the one or more indicators could be or could correspond to one or more 1-bit indicators each corresponding/associated to a candidate RS/RS resource/RS resource index or one of the candidate RS(s) or RS resource(s) or RS resource index(es). As discussed/specified herein in the present disclosure, when/if a 1-bit indicator is set to ‘1’ (or ‘0’), the UE could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators provided, indicated, contained, comprised, configured or indicated in a/the higher layer parameter TCI-State or TCI-UL-State that configures or provides the indicated TCI state associated/corresponding to the RS index #1, RS index #2 and RS index #K are set to ‘1’s while the 1-bit indicators provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators provided, indicated, contained, comprised, configured or indicated in a/the higher layer parameter TCI-State or TCI-UL-State that configures or provides the indicated TCI state that are set to ‘1’s could be used/applied as the RS(s) or RS resource(s) for the actual measurement for/of the one or more candidate/new beams.

For the described/specified design examples herein, when/if the higher layer parameter TCI-State or TCI-UL-State that configures or provides the indicated TCI state does not provide, contain, indicate, include, comprise or configure any of the one or more indicators as specified/defined herein in the present disclosure, and/or the one or more indicators as specified/defined herein in the present disclosure is absent or not present in the higher layer parameter TCI-State or TCI-UL-State that configures or provides the indicated TCI state, the UE could assess or evaluate the radio link/beam quality(s), e.g., by measuring the L1-RSRP(s)/L1-SINR(s), of the candidate RS(s) or RS resource(s) or RS resource index(es) configured following those specified/described in the explicit configuration example-A/B and/or determined following those specified/described in the implicit determination example-A, the implicit determination example-B, the implicit determination example-C and/or the implicit determination example-D to obtain the actual corresponding measurement result(s) for/of the one or more candidate/new beams. As specified or discussed herein in the present disclosure, a/the UE could indicate or send or transmit to the network, e.g., by/in part of their capability or capability signaling, whether or not they are capable of receiving/detecting/using/applying or support to receive/detect/use/apply the one or more indicators as defined/specified herein in the present disclosure to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; for instance, a/the UE could indicate or send or transmit to the network, e.g., by/in part of their capability or capability signaling, whether or not they are capable of receiving/detecting/using/applying or support to receive/detect/use/apply the one or more indicators provided, contained, indicated, included, comprised or configured in the higher layer parameter TCI-State or TCI-UL-State that configures or provides the indicated TCI state as defined/specified herein in the present disclosure to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams. Optionally, when/if a/the total number of the candidate RS(s) or RS resource(s) or RS resource index(es) configured following those specified/described in the present disclosure, e.g., those specified/described in the explicit configuration example-A/B, to obtain the actual corresponding measurement result(s) for/of the one or more candidate/new beams is greater than or equal to a first threshold/number/value, the UE could expect to or could (i) receive/detect/apply/use the one or more indicators as defined/specified herein in the present disclosure, e.g., provided, contained, indicated, included, comprised or configured in the higher layer parameter TCI-State or TCI-UL-State that configures or provides the indicated TCI state, (ii) follow those specified in the implicit determination example-A/B/C/D, and/or (iii) follow other subset based candidate RS(s)/RS resource(s)/RS resource index(es) indication/identification/determination method(s) as discussed or specified herein in the present disclosure, to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; otherwise, i.e., when/if a/the total number of the candidate RS(s) or RS resource(s) or RS resource index(es) configured following those specified/described in the present disclosure, e.g., those specified/described in the explicit configuration example-A/B, to obtain the actual corresponding measurement result(s) for/of the one or more candidate/new beams is less than or equal to the first threshold/number/value, the UE (e.g., the UE 116) could assess or evaluate the radio link/beam quality(s), e.g., by measuring the L1-RSRP(s)/L1-SINR(s), of the candidate RS(s) or RS resource(s) or RS resource index(es) configured following those specified/described in the explicit configuration example-A/B to obtain the actual corresponding measurement result(s) for/of the one or more candidate/new beams. In this case, the UE could determine or identify the first threshold/value/number according to or based on: (i) a fixed value in system specification(s) or per RRC (re) configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network (e.g., the network 130) via various UL channels/signals including PUCCH(s), PUSCH(s), PRACH(s), and/or etc., e.g., in part of a CSI/beam report and/or UE's capability signaling(s). Alternatively, when/if a/the total number of the one or more TCI states activated by/in the TCI state(s) activation/deactivation MAC CE command (or a/the total number of the corresponding RS(s)/RS resource(s)/RS resource index(es) associated to/with the one or more TCI states as specified in the implicit determination example-A/B) and/or a/the total number of the one or more TCI states provided/configured in a higher layer RRC cμonfigured list of TCI state(s)—or a/the total number of the corresponding RS(s)/RS resource(s)/RS resource index(es) associated to/with the one or more TCI states as specified in the implicit determination example-C/μD—is less than or equal to a second threshold/value/number, the UE could expect to or could (i) receive/detect/apply/use the one or more indicators as defined/specified herein in the present disclosure, e.g., provided, contained, indicated, included, comprised or configured in the higher layer parameter TCI-State or TCI-UL-State that configures or provides the indicated TCI state, and/or (ii) follow those specified in the explicit configuration example-A/B, to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; otherwise, i.e., when/if a/the total number of the one or more TCI states activated by/in the TCI state(s) activation/deactivation MAC CE command (or a/the total number of the corresponding RS(s)/RS resource(s)/RS resource index(es) associated to/with the one or more TCI states as specified in the implicit determination example-A/B) and/or a/the total number of the one or more TCI states provided/configured in a higher layer RRC configured list of TCI state(s)—or a/the total number of the corresponding RS(s)/RS resource(s)/RS resource index(es) associated to/with the one or more TCI states as specified in the implicit determination example-C/D—is greater than or equal to the second threshold/value/number, the UE could assess or evaluate the radio link/beam quality(s), e.g., by measuring the L1-RSRP(s)/L1-SINR(s), of the candidate RS(s) or RS resource(s) or RS resource index(es) determined following those specified/described in the implicit determination example-A, the implicit determination example-B, the implicit determination example-C and/or the implicit determination example-D to obtain the actual corresponding measurement result(s) for/of the one or more candidate/new beams. In this case, the UE could determine or identify the second threshold/value/number according to or based on: (i) a fixed value in system or per specification(s) RRC (re) configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

Furthermore, the UE could first determine or identify, e.g., based on or according to (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s), one or more first candidate TCI states, wherein the first candidate TCI state(s) could be from a list of TCI state(s) higher layer configured or provided by the network, e.g., a list of joint/DL TCI state(s) provided by DLorJointTCI-State, and/or a set of TCI state(s) activated in/by a TCI state(s) activation/deactivation MAC CE command, and the (QCL source) RS(s) or RS resource(s) or RS resource index(es) provided in each of the first candidate TCI state(s) could correspond to a candidate candidate/new beam RS or RS resource or RS resource index as specified/defined herein in the present disclosure. Additionally, the UE could also determine or identify one or more of or a subset of the first candidate TCI state(s) as one or more second candidate TCI state(s) following or according to those specified or defined herein in the present disclosure for determining or identifying the actual candidate/new beam RS(s)/RS resource(s)/RS resource index(es) from the candidate candidate/new beam RS(s)/RS resource(s)/RS resource index(es)—including the indication(s)/configuration(s)/usage(s)/application(s) of the one or more indicators such as bitmap(s)/1-bit indicator(s)/etc. as specified/defined herein in the present disclosure, wherein the (QCL source) RS(s) or RS resource(s) or RS resource index(es) provided in each of the second candidate TCI state(s) could correspond to an actual candidate/new beam RS or RS resource or RS resource index as defined/specified herein in the present disclosure.

As described or specified herein in the present disclosure, a RS or RS resource or RS resource index of/for a current serving beam—denoted by a current serving beam RS/RS resource/RS resource index—could be corresponding/associated/mapped to one or more of (or a subset of) candidate RSs or RS resources or RS resource indexes—denoted by candidate candidate/new beam RS(s)/RS resource(s)/RS resource index(es)—used/applied as the RS(s) or RS resource(s) or RS resource index(es) for actual measurement(s) of/for one or more candidate/new beams—denoted by actual candidate/new beam RS(s)/RS resource(s)/RS resource index(es), wherein the current serving beam RS/RS resource/RS resource index and/or the candidate or actual candidate/new beam RS(s)/RS resource(s)/RS resource index(es) could be configured and/or determined according to those specified herein in the present disclosure.

In one example, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure.

For example, as described/specified herein in the present disclosure, the current serving beam RS/RS resource/RS resource index (or equivalently, the QCL source RS/RS resource/RS resource index) in the indicated TCI state provided by TCI-State or TCI-UL-State could be corresponding/associated/mapped to the actual candidate/new beam RS(s)/RS resource(s)/RS resource index(es)—i.e., a subset of or one or more of the candidate candidate/new beam RS(s)/RS resource(s)/RS resource index(es) following those specified herein in the present disclosure—provided, indicated, configured, comprised, included or contained in the same higher layer parameter(s) TCI-State or TCI-UL-State that provides or configures the indicated TCI state.

For another example, a/the higher layer RRC signaling(s)/parameter(s) and/or MAC CE command(s) and/or dynamic DCI based L1 signaling(s) that provides or configures or indicates a current serving beam RS/RS resource/RS resource index could include, contain, provide, indicate, comprise or configure one or more actual candidate/new beam RSs/RS resources/RS resource indexes and/or the one or more indicators as specified/defined herein in the present disclosure that point/correspond to or represent or indicate one or more actual candidate/new beam RSs/RS resources/RS resource indexes—i.e., a subset of or one or more of the candidate candidate/new beam RS(s)/RS resource(s)/RS resource index(es) following those specified herein in the present disclosure. For this design example, the current serving beam RS/RS resource/RS resource index could be associated/mapped/corresponding to the one or more actual candidate/new beam RSs/RS resources/RS resource indexes.

For another example, a/the higher layer RRC signaling(s)/parameter(s) and/or MAC CE command(s) and/or dynamic DCI based L1 signaling(s) that provides or configures or indicates one or more actual candidate/new beam RSs/RS resources/RS resource indexes and/or the one or more indicators as specified/defined herein in the present disclosure that point/correspond to or represent or indicate one or more actual candidate/new beam RSs/RS resources/RS resource indexes—i.e., a subset of or one or more of the candidate candidate/new beam RS(s)/RS resource(s)/RS resource index(es) following those specified herein in the present disclosure-could include, contain, provide, indicate, comprise or configure a current serving beam RS/RS resource/RS resource index. For this design example, the current serving beam RS/RS resource/RS resource index could be associated/mapped/corresponding to the one or more actual candidate/new beam RSs/RS resources/RS resource indexes.

For another example, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more indicators; as specified/defined herein in the present disclosure, the one or more indicators could point/correspond to or represent or indicate one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure. For this design example, the current serving beam RS/RS resource/RS resource index could be associated/mapped/corresponding to the one or more actual candidate/new beam RSs/RS resources/RS resource indexes—via/by their associations to the one or more indicators as specified/defined herein in the present disclosure.

For another example, the UE could be first configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a single/same set/list of RSs or RS resources or RS resource indexes that comprise, contain, include, provide, configure or indicate both a current serving beam RS/RS resource/RS resource index (e.g., the first entry in the set/list or the entry with the lowest/highest RS index or RS resource index in the set/list) and one or more actual candidate/new beam RSs/RS resources/RS resource indexes (e.g., the remaining or rest of the entries in the set/list other than the first entry or the entry with the lowest/highest RS index or RS resource index). Optionally, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling—e.g., via one or more bitmaps and/or 1-bit indicators and/or etc. similar to those described/specified herein in the present disclosure, which one of the RSs or RS resources or RS resource indexes in the set/list could correspond to the current serving beam RS or RS resource or RS resource index and/or which one or more of the RSs or RS resources or RS resource indexes in the set/list could correspond to the actual candidate/new beam RS(s) or RS resource(s) or RS resource index(es). Alternatively, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of current serving beam RS(s)/RS resource(s)/RS resource index(es), and/or a second list/set of candidate/actual candidate/new beam RS(s)/RS resource(s)/RS resource index(es); in this case, the UE could then identify or determine, according to or based on the first list/set, the current serving beam RS/RS resource/RS resource index in the set/list, and/or identify or determine, according to or based on the second list/set, the actual candidate/new beam RS(s)/RS resource(s)/RS resource index(es) in the set/list. For this design example, the current serving beam RS/RS resource/RS resource index could be associated/mapped/corresponding to the one or more actual candidate/new beam RSs/RS resources/RS resource indexes as defined/specified herein.

For another example, the UE could be first configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, an overall set/list of RSs or RS resources or RS resource indexes that comprise, contain, include, provide, configure or indicate both one or more current serving beam RSs/RS resources/RS resource indexes and one or more actual candidate/new beam RSs/RS resources/RS resource indexes. For this design example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling—e.g., via one or more bitmaps and/or 1-bit indicators and/or etc. similar to those described/specified herein in the present disclosure, which one or more of the RSs or RS resources or RS resource indexes in the overall set/list could correspond to the current serving beam RS(s) or RS resource(s) or RS resource index(es) and/or which one or more of the RSs or RS resources or RS resource indexes in the overall set/list could correspond to the actual candidate/new beam RS(s) or RS resource(s) or RS resource index(es). For instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of current serving beam RS(s)/RS resource(s)/RS resource index(es), and/or a second list/set of candidate/actual candidate/new beam RS(s)/RS resource(s)/RS resource index(es); in this case, the UE could then identify or determine, according to or based on the first list/set, the current serving beam RS(s)/RS resource(s)/RS resource index(es) in the overall set/list, and/or identify or determine, according to or based on the second list/set, the actual candidate/new beam RS(s)/RS resource(s)/RS resource index(es) in the overall set/list. Additionally, for a current serving beam RS/RS resource/RS resource index in the overall set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between the current serving beam RS/RS resource/RS resource index and one or more indicators; similar to those specified/defined herein in the present disclosure, the one or more indicators could point/correspond to or represent or indicate one or more actual candidate/new beam RSs/RS resources/RS resource indexes (i.e., from/among/out of the actual candidate/new beam RSs/RS resources/RS resource indexes in the overall set/list); in this case, the current serving beam RS/RS resource/RS resource index could be associated/mapped/corresponding to the one or more actual candidate/new beam RSs/RS resources/RS resource indexes-via/by their associations to the one or more indicators as specified/defined herein in the present disclosure.

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a second list/set of one or more candidate/actual candidate/new beam RSs or RS resources or RS resource indexes. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of or a subset of the candidate/actual candidate/new beam RS(s) or RS resource(s) or RS resource index(es) in the second set/list could be associated/mapped/corresponding to the current serving beam RS/RS resource/RS resource index.

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more second lists/sets of one or more candidate/actual candidate/new beam RSs or RS resources or RS resource indexes each comprising one or more candidate/actual candidate/new beam RSs or RS resources or RS resource indexes. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of the second sets/lists (and therefore, the corresponding candidate/actual candidate/new beam RS(s)/RS resource(s)/RS resource index(es) comprised or provided therein) could be associated/mapped/corresponding to the current serving beam RS/RS resource/RS resource index.

In another example, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more second candidate TCI states (i.e., a subset of or one or more of the first candidate TCI state(s)), and therefore the corresponding actual candidate/new beam RS(s)/RS resource(s)/RS resource index(es) provided therein, determined or configured or identified according to those specified/described herein in the present disclosure.

For example, as described/specified herein in the present disclosure, the current serving beam RS/RS resource/RS resource index (or equivalently, the QCL source RS/RS resource/RS resource index) in the indicated TCI state provided by TCI-State or TCI-UL-State could be corresponding/associated/mapped to the actual candidate/new beam RS(s)/RS resource(s)/RS resource index(es)—i.e., a subset of or one or more of the candidate candidate/new beam RS(s)/RS resource(s)/RS resource index(es) following those specified herein in the present disclosure-provided, indicated, configured, comprised, included or contained in one or more second candidate TCI states whose ID(s), index(es) or related information-such as the one or more indicators used to determine or identify or indicate the one or more second candidate TCI states from or out of one or more first candidate TCI states—could be provided, indicated, configured, comprised, included or contained in the same higher layer parameter(s) TCI-State or TCI-UL-State that provides or configures the indicated TCI state.

For another example, a/the higher layer RRC signaling(s)/parameter(s) and/or MAC CE command(s) and/or dynamic DCI based L1 signaling(s) that provides or configures or indicates a current serving beam RS/RS resource/RS resource index could include, contain, provide, indicate, comprise or configure one or more second candidate TCI states (e.g., in form of their IDs, indexes and/or other related information) and/or the one or more indicators as specified/defined herein in the present disclosure that point/correspond to or represent or indicate one or more second candidate TCI states—i.e., a subset of or one or more of the first candidate TCI states following those specified herein in the present disclosure. For this design example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—e.g., as the QCL source RS(s)/RS resource(s)/RS resource index(es).

For another example, a/the higher layer RRC signaling(s)/parameter(s) and/or MAC CE command(s) and/or dynamic DCI based L1 signaling(s) that provides or configures or indicates one or more second candidate TCI states (e.g., in form of their IDs, indexes and/or other related information) and/or the one or more indicators as specified/defined herein in the present disclosure that point/correspond to or represent or indicate one or more second candidate TCI states—i.e., a subset of or one or more of the first candidate TCI states following those specified herein in the present disclosure-could include, contain, provide, indicate, comprise or configure a current serving beam RS/RS resource/RS resource index. For this design example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—e.g., as the QCL source RS(s)/RS resource(s)/RS resource index(es).

For another example, the UE (e.g., the UE 116) could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more indicators; as specified/defined herein in the present disclosure, the one or more indicators could point/correspond to or represent or indicate one or more second candidate TCI states—i.e., a subset of or one or more of the first candidate TCI states following those specified herein in the present disclosure. For this design example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—via/by their associations to the one or more indicators as specified/defined herein in the present disclosure.

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network (e.g., the network 130), e.g., via/by higher layer RRC signaling(s)/parameter(s) and/or MAC CE command(s) and/or dynamic DCI based L1 signaling(s) based on or according to a corresponding UE's capability or capability signaling, a second list/set of one or more first/second candidate TCI states (e.g., in form of their IDs/indexes/etc.) as specified/defined herein in the present disclosure. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of or a subset of the first/second candidate TCI states in the second set/list—and therefore the corresponding candidate/actual candidate/new beam RS(s) or RS resource(s) or RS resource index(es) provided/indicated therein (i.e., in the corresponding first/second candidate TCI state(s))—could be associated/mapped/corresponding to the current serving beam RS/RS resource/RS resource index.

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more second lists/sets of one or more first/second candidate TCI states (e.g., in form of their IDs/indexes/etc.) as specified/defined herein in the present disclosure each comprising one or more first/second candidate TCI states (e.g., in form of their IDs/indexes/etc.). For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of the second sets/lists of first/second TCI state(s)—and therefore the corresponding candidate/actual candidate/new beam RS(s) or RS resource(s) or RS resource index(es) provided/indicated therein (i.e., in the corresponding first/second candidate TCI state(s))—could be associated/mapped/corresponding to the current serving beam RS/RS resource/RS resource index.

In another example, the UE could determine or identify, based on or according to, e.g. fixed rule(s) in system specification(s) and/or per RRC (re) configuration, the correspondence(s)/association(s)/mapping(s) between a current serving beam RS/RS resource/RS resource index determined or configured or identified according to those specified/described herein in the present disclosure and one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure.

For example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of candidate/actual candidate/new beam RS(s)/RS resource(s)/RS resource index(es) as defined/specified herein in the present disclosure, wherein each set/list could be associated with a set ID/index and could comprise one or more candidate/actual candidate/new beam RSs/RS resources/RS resource indexes as defined/specified herein in the present disclosure. For a current serving beam RS or RS resource, when/if its corresponding RS index or RS resource index or RS resource configuration index has the same value as the set ID/index of a set/list of one or more candidate/actual candidate/new beam RS(s)/RS resource(s)/RS resource index(es), the current serving beam RS/RS resource/RS resource index could be associated/mapped/corresponding to the one or more candidate/actual candidate/new beam RSs/RS resources/RS resource indexes in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the set/list of candidate/actual candidate/new beam RSs/RS resources with the lowest (or highest) set ID/index, the current serving beam RS/RS resource with the second lowest (or second highest) RS index or RS resource index or RS resource configuration index could be associated/mapped/corresponding to the set/list of candidate/actual candidate/new beam RSs/RS resources with the second lowest (or second highest) set ID/index, and so on, and the current serving beam RS/RS resource with the highest (or lowest) RS index or RS resource index or RS resource configuration index could be associated/mapped/corresponding to the set/list of candidate/actual candidate/new beam RSs/RS resources with the highest (or lowest) set ID/index.

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of candidate/actual candidate/new beam RS(s)/RS resource(s)/RS resource index(es) as defined/specified herein in the present disclosure, wherein each set/list could be associated with a set ID/index and could comprise one or more candidate/actual candidate/new beam RSs/RS resources/RS resource indexes as defined/specified herein in the present disclosure. For a current serving beam RS or RS resource, when/if its corresponding RS index or RS resource index or RS resource configuration index and the set ID/index of a set/list of one or more candidate/actual candidate/new beam RS(s)/RS resource(s)/RS resource index(es) are correlated or related, the current serving beam RS/RS resource/RS resource index could be associated/mapped/corresponding to the one or more candidate/actual candidate/new beam RSs/RS resources/RS resource indexes in the set/list. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. The set/list of candidate/actual candidate/new beam RSs/RS resources/RS resource indexes as defined/specified herein in the present disclosure could be further divided or separated into one or more groups each comprising one or more (e.g., a fixed number) candidate/actual candidate/new beam RSs/RS resources/RS resource indexes. For a current serving beam RS or RS resource, when/if its corresponding RS index or RS resource index or RS resource configuration index (e.g., the first or #1, second or #2, etc.) has the same value as the ordering/position (e.g., the first, second, etc.) of a group of candidate/actual candidate/new beam RS(s)/RS resource(s)/RS resource index(es) among the groups in the set/list, the current serving beam RS/RS resource/RS resource index could be associated/mapped/corresponding to the one or more candidate/actual candidate/new beam RSs/RS resources/RS resource indexes in the group. Optionally, for one or more current serving beam RSs or RS resources or RS resource indexes, the current serving beam RS/RS resource with the lowest (or highest) RS index or RS resource index or RS resource configuration index could be associated/mapped/corresponding to the group of candidate/actual candidate/new beam RSs/RS resources with the lowest (or highest) ordering/position among the groups in the set/list, the current serving beam RS/RS resource with the second lowest (or second highest) RS index or RS resource index or RS resource configuration index could be associated/mapped/corresponding to the group of candidate/actual candidate/new beam RSs/RS resources with the second lowest (or second highest) ordering/position among the groups in the set/list, and so on, and the current serving beam RS/RS resource with the highest (or lowest) RS index or RS resource index or RS resource configuration index could be associated/mapped/corresponding to the group of candidate/actual candidate/new beam RSs/RS resources with the highest (or lowest) ordering/position among the groups in the set/list.

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. The set/list of candidate/actual candidate/new beam RSs/RS resources/RS resource indexes as defined/specified herein in the present disclosure could be further divided or separated into one or more groups each comprising one or more (e.g., a fixed number) candidate/actual candidate/new beam RSs/RS resources/RS resource indexes. For a current serving beam RS or RS resource, when/if its corresponding RS index or RS resource index or RS resource configuration index (e.g., the first or #1, second or #2, etc.) and the ordering/position (e.g., the first, second, etc.) of a group of candidate/actual candidate/new beam RS(s)/RS resource(s)/RS resource index(es) among the groups in the set/list are correlated or related, the current serving beam RS/RS resource/RS resource index could be associated/mapped/corresponding to the one or more candidate/actual candidate/new beam RSs/RS resources/RS resource indexes in the group. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. For a current serving beam RS or RS resource, when/if its corresponding RS index or RS resource index or RS resource configuration index has the same value as the RS index(es) or RS resource index(es) or RS resource configuration index(es) of one or more candidate/actual candidate/new beam RSs or RS resources, the current serving beam RS/RS resource/RS resource index could be associated/mapped/corresponding to the one or more candidate/actual candidate/new beam RSs/RS resources/RS resource indexes in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the candidate/actual candidate/new beam RSs/RS resources with the lowest (or highest) RS index(es) or RS resource index(es) or RS resource configuration index(es), the current serving beam RS/RS resource with the second lowest (or second highest) RS index or RS resource index or RS resource configuration index could be associated/mapped/corresponding to the candidate/actual candidate/new beam RSs/RS resources with the second lowest (or second highest) RS index(es) or RS resource index(es) or RS resource configuration index(es), and so on, and the current serving beam RS/RS resource with the highest (or lowest) RS index or RS resource index or RS resource configuration index could be associated/mapped/corresponding to the candidate/actual candidate/new beam RSs/RS resources with the highest (or lowest) RS index(es) or RS resource index(es) or RS resource configuration index(es).

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. For a current serving beam RS or RS resource, when/if its corresponding RS index or RS resource index or RS resource configuration index and the RS index(es) or RS resource index(es) or RS resource configuration index(es) of one or more candidate/actual candidate/new beam RSs or RS resources are correlated or related, the current serving beam RS/RS resource/RS resource index could be associated/mapped/corresponding to the one or more candidate/actual candidate/new beam RSs/RS resources/RS resource indexes in the set/list. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. The UE could first determine or identify the one or more current serving beam RSs/RS resources/RS resource indexes in the set/list, and/or the one or more candidate/actual candidate/new beam RSs/RS resources/RS resource indexes in the set/list according to or following those specified herein in the present disclosure. The UE could then determine or identify the association(s)/mapping(s)/correspondence(s) between the one or more current serving beam RSs/RS resources/RS resource indexes in the set/list and the one or more candidate/actual candidate/new beam RSs/RS resources/RS resource indexes in the set/list according to or following those specified herein in the present disclosure.

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. For this design example, the entry(s)/position(s)/ordering(s)—e.g., the first, second, etc.—in the set/list that could carry, convey, contain, include, provide or indicate the one or more current serving beam RSs/RS resources/RS resource indexes could be fixed; alternatively, the RS index(es)/RS resource index(es)/RS resource configuration index(es) in the set/list that could correspond or refer to the one or more current serving beam RSs/RS resources/RS resource indexes could be fixed. In this case, the P≥1 entry(s)/position(s)/ordering(s) in the set/list that follow the entry(s)/position(s)/ordering(s) in the set/list that carries, conveys, contains, includes, provides or indicates the current serving beam RS(s)/RS resource(s)/RS resource index(es) could carry, convey, contain, include, provide or indicate the one or more candidate/actual candidate/new beam RSs/RS resources/RS resource indexes that are corresponding/associated/mapped to the current serving beam RS(s)/RS resource(s)/RS resource index(es). Alternatively, the P≥1 entry(s)/position(s)/ordering(s) in the set/list that follow the RS index(es) or RS resource index(es) or RS resource configuration index(es) in the set/list that corresponds or refers to the current serving beam RS(s)/RS resource(s)/RS resource index(es) could carry, convey, contain, include, provide or indicate the one or more candidate/actual candidate/new RSs/RS resources/RS resource indexes that beam are corresponding/associated/mapped to the current serving beam RS(s)/RS resource(s)/RS resource index(es). The value of P could be determined or identified according to: (i) a fixed value in system specification(s) or per RRC (re) configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. For this design example, the first Q≥1 entry(s)/position(s)/ordering(s) in the set/list could carry, convey, contain, include, provide or indicate the one or more current serving beam RSs/RS resources/RS resource indexes; alternatively, the Q≥1 lowest/highest RS index(es)/RS resource index(es)/RS resource configuration index(es) in the set/list could correspond or refer to the one or more current serving beam RSs/RS resources. In this case, the rest of or remaining entry(s)/position(s)/ordering(s) in the set/list could carry, convey, contain, include, provide or indicate the one or more candidate/actual candidate/new beam RSs/RS resources/RS resource indexes, and/or the rest of or remaining RS index(es)/RS resource index(es)/RS resource configuration index(es) in the set/list could correspond or refer to the one or more candidate/actual candidate/new beam RSs or RS resources. The value of Q could be determined or identified according to: (i) a fixed value in system specification(s) or per RRC (re) configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). Furthermore, the UE could determine or identify the association(s)/mapping(s)/correspondence(s) between the one or more current serving beam RSs/RS resources/RS resource indexes in the set/list and the one or more candidate/actual candidate/new beam RSs/RS resources/RS resource indexes in the set/list according to or following those specified herein in the present disclosure.

In another example, the UE could determine or identify, based on or according to, e.g. fixed rule(s) in system specification(s) and/or per RRC (re) configuration, the correspondence(s)/association(s)/mapping(s) between a current serving beam RS/RS resource/RS resource index determined or configured or identified according to those specified/described herein in the present disclosure and one or more second candidate TCI states (i.e., a subset of or one or more of the first candidate TCI state(s)), and therefore the corresponding actual candidate/new beam RS(s)/RS resource(s)/RS resource index(es) provided therein, determined or configured or identified according to those specified/described herein in the present disclosure.

For example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of first/second candidate TCI state(s)—e.g., in form of TCI state ID(s)/index(es)/etc.—as defined/specified herein in the present disclosure, wherein each set/list could be associated with a set ID/index and could comprise one or more first/second candidate TCI states as defined/specified herein in the present disclosure. For a current serving beam RS or RS resource, when/if its corresponding RS index or RS resource index or RS resource configuration index has the same value as the set ID/index of a set/list of one or more first/second candidate TCI states, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated therein—with the lowest (or highest) set ID/index, the current serving beam RS/RS resource with the second lowest (or second highest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated—with the second lowest (or second highest) set ID/index, and so on, and the current serving beam RS/RS resource with the highest (or lowest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated therein—with the highest (or lowest) set ID/index.

For another example, the UE (e.g., the UE 116) could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of first/second candidate TCI state(s)—e.g., in form of TCI state ID(s)/index(es)/etc.—as defined/specified herein in the present disclosure, wherein each set/list could be associated with a set ID/index and could comprise one or more first/second candidate TCI states as defined/specified herein in the present disclosure. For a current serving beam RS or RS resource, when/if its corresponding RS index or RS resource index or RS resource configuration index and the set ID/index of a set/list of one or more first/second candidate TCI state(s) are correlated or related, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For another example, the UE could be configured, indicated or provided by the network (e.g., the network 130), e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states—e.g., in form of TCI state ID(s)/index(es)/etc.—as defined/specified herein in the present disclosure. The set/list of first/second candidate TCI state(s) as defined/specified herein in the present disclosure could be further divided or separated into one or more groups each comprising one or more (e.g., a fixed number) first/second candidate TCI states. For a current serving beam RS or RS resource, when/if its corresponding RS index or RS resource index or RS resource configuration index (e.g., the first or #1, second or #2, etc.) has the same value as the ordering/position (e.g., the first, second, etc.) of a group of first/second candidate TCI state(s) among the groups in the set/list, the current serving beam RS/RS resource/RS resource index could be associated/mapped/corresponding to the candidate/actual candidate/new beam RS(s)/RS resource(s)/RS resource index(es) provided or indicated in/by the first/second candidate TCI state(s) in the group. Optionally, for one or more current serving beam RSs or RS resources or RS resource indexes, the current serving beam RS/RS resource with the lowest (or highest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the lowest (or highest) ordering/position among the groups in the set/list, the current serving beam RS/RS resource with the second lowest (or second highest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the second lowest (or second highest) ordering/position among the groups in the set/list, and so on, and the current serving beam RS/RS resource with the highest (or lowest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the highest (or lowest) ordering/position among the groups in the set/list.

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. The set/list of first/second candidate TCI states as defined/specified herein in the present disclosure could be further divided or separated into one or more groups each comprising one or more (e.g., a fixed number) first/second candidate TCI states. For a current serving beam RS or RS resource, when/if its corresponding RS index or RS resource index or RS resource configuration index (e.g., the first or #1, second or #2, etc.) and the ordering/position (e.g., the first, second, etc.) of a group of first/second candidate TCI states among the groups in the set/list are correlated or related, the current serving beam RS/RS resource/RS resource index could be associated/mapped/corresponding to the candidate/actual candidate/new beam RS(s)/RS resource(s)/RS resource index(es) provided or indicated in/by the first/second candidate TCI states in the group. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. For a current serving beam RS or RS resource, when/if its corresponding RS index or RS resource index or RS resource configuration index has the same value as the TCI state ID(s)/index(es) of one or more first/second candidate TCI states, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the first/second candidate TCI state(s) with the lowest (or highest) TCI state ID(s)/index(es)—and therefore the corresponding candidate/actual candidate/new beam RS(s)/RS resource(s)/RS resource index(es) provided or indicated therein, the current serving beam RS/RS resource with the second lowest (or second highest) RS index or RS resource index or RS resource configuration index could be associated/mapped/corresponding to the first/second candidate TCI state(s) with the second lowest (or second highest) TCI state ID(s)/index(es)—and therefore the corresponding candidate/actual candidate/new beam RS(s)/RS resource(s)/RS resource index(es) provided or indicated therein, and so on, and the current serving beam RS/RS resource with the highest (or lowest) RS index or RS resource index or RS resource configuration index could be associated/mapped/corresponding to the first/second candidate TCI state(s) with the highest (or lowest) TCI state ID(s)/index(es)—and therefore the corresponding candidate/actual candidate/new beam RS(s)/RS resource(s)/RS resource index(es) provided or indicated therein.

For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. For a current serving beam RS or RS resource, when/if its corresponding RS index or RS resource index or RS resource configuration index and the TCI state ID(s)/index(es) of one or more first/second candidate TCI states are correlated or related, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For the described or specified design examples herein, or for the design examples described or specified herein in the present disclosure, a UE could first identify or determine a current serving beam RS/RS resource/RS resource index according to or following those specified herein in the present disclosure, and perform the corresponding measurement(s)—e.g., by assessing or evaluating the radio link/beam quality(s) including measuring the L1-RSRP(s)/L1-SINR(s)—of the identified or determined current serving beam RS or RS resource or RS resource configuration. The UE could then identify or determine one or more actual candidate/new beam RSs/RS resources/RS resource indexes that are associated/mapped/corresponding to the determined or identified current serving beam RS/RS resource/RS resource index according to or following those specified herein in the present disclosure, and perform the corresponding measurement(s)—e.g., by assessing or evaluating the radio link/beam quality(s) including measuring the L1-RSRP(s)/L1-SINR(s)—of the identified or determined actual candidate/new beam RS(s) or RS resource(s) or RS resource configuration(s).

Furthermore, the UE could determine or identify one or more candidate or actual candidate/new beam RSs or RS resources or RS resource indexes according to or following those specified herein in the present disclosure. The UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure:
(Case-I) According to or that have the same value(s) of RS index(es) or RS resource index(es) or RS resource configuration index(es) as that of the RS(s) or RS resource(s) or RS resource index(es) or RS resource configuration index(es) provided in/by the TCI state(s) and/or the joint/DL TCI state(s) activated or provided or indicated or contained or included or comprised by/in a (unified) TCI state(s) activation/deactivation MAC CE command.
(Case-II) According to or that have the same value(s) of RS index(es) or RS resource index(es) or RS resource configuration index(es) as that of the RS(s) or RS resource(s) or RS resource index(es) or RS resource configuration index(es) provided in/by one or more of (or a subset of) the TCI state(s) and/or one or more of (or a subset of) the joint/DL TCI state(s) activated or provided or indicated or contained or included or comprised by/in a (unified) TCI state(s) activation/deactivation MAC CE command. The one or more of (or the subset of) the TCI state(s) and/or the one or more of (or the subset of) the joint/DL TCI state(s) activated or provided or indicated or contained or included or comprised by/in a (unified) TCI state(s) activation/deactivation MAC CE command—e.g., among or out of the TCI state(s) and/or the joint/DL TCI state(s) activated or provided or indicated or contained or included or comprised by/in the (unified) TCI state(s) activation/deactivation MAC CE command—could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
(Case-III) According to or that have the same value(s) of RS index(es) or RS resource index(es) or RS resource configuration index(es) as that of the RS(s) or RS resource(s) or RS resource index(es) or RS resource configuration index(es) provided in/by the TCI state(s) in a list of TCI state(s) higher layer configured or provided to the UE, e.g., the joint/DL TCI state(s) provided or configured in/by DLorJointTCI-State.
(Case-IV) According to or that have the same value(s) of RS index(es) or RS resource index(es) or RS resource configuration index(es) as that of the RS(s) or RS resource(s) or RS resource index(es) or RS resource configuration index(es) provided in/by one or more of (or a subset of) the TCI state(s) in a list of TCI state(s) higher layer configured or provided to the UE, e.g., the joint/DL TCI state(s) provided or configured in/by DLorJointTCI-State. The one or more of (or the subset of) the TCI state(s) in the list of TCI state(s), e.g., DLorJointTCI-State, higher layer configured or provided to the UE—e.g., among or out of the TCI state(s) in the list of TCI state(s) higher layer configured or provided to the UE, e.g., the joint/DL TCI state(s) provided or configured in/by DLorJointTCI-State—could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

The UE could first assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according to or following those specified/described in Case-II.
Under Case-II, if the UE could identify or determine a L_min≥1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according to or following those specified/described in Case-I;
Under Case-I, if the UE could identify or determine a L_min>1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according to or following those specified/described in Case-IV;
Under Case-IV, if the UE could identify or determine a L_min≥1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure according to or following those specified/described in Case-III;
Under Case-III, if the UE could identify or determine a L_min≥1 number of candidate/actual new beam RS(s) or RS resource(s) or RS resource index(es) that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could assess or evaluate the radio link or beam quality(s)—e.g., by measuring L1-RSRP(s)/L1-SINR(s)—of the determined or identified one or more candidate/actual new beam RSs or RS resources or RS resource configurations as specified/defined herein in the present disclosure.

As specified/defined herein in the present disclosure, a UE could (implicitly) determine one or more candidate/actual new beam RSs or RS resources or RS resource configurations
(Case-V) as the RS(s) or RS resource(s) or RS resource index(es) or RS resource configuration index(es) provided in/by the TCI state(s) and/or the joint/DL TCI state(s) activated or provided or indicated or contained or included or comprised by/in a (unified) TCI state(s) activation/deactivation MAC CE command.
(Case-VI) as the RS(s) or RS resource(s) or RS resource index(es) or RS resource configuration index(es) provided in/by one or more of (or a subset of) the TCI state(s) and/or one or more of (or a subset of) the joint/DL TCI state(s) activated or provided or indicated or contained or included or comprised by/in a (unified) TCI state(s) activation/deactivation MAC CE command. The one or more of (or the subset of) the TCI state(s) and/or the one or more of (or the subset of) the joint/DL TCI state(s) activated or provided or indicated or contained or included or comprised by/in a (unified) TCI state(s) activation/deactivation MAC CE command—e.g., among or out of the TCI state(s) and/or the joint/DL TCI state(s) activated or provided or indicated or contained or included or comprised by/in the (unified) TCI state(s) activation/deactivation MAC CE command-could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
(Case-VII) as the RS(s) or RS resource(s) or RS resource index(es) or RS resource configuration index(es) provided in/by the TCI state(s) in a list of TCI state(s) higher layer configured or provided to the UE, e.g., the joint/DL TCI state(s) provided or configured in/by DLorJointTCI-State.
(Case-VIII) as the RS(s) or RS resource(s) or RS resource index(es) or RS resource configuration index(es) provided in/by one or more of (or a subset of) the TCI state(s) in a list of TCI state(s) higher layer configured or provided to the UE, e.g., the joint/DL TCI state(s) provided or configured in/by DLorJointTCI-State. The one or more of (or the subset of) the TCI state(s) in the list of TCI state(s), e.g., DLorJointTCI-State, higher layer configured or provided to the UE—e.g., among or out of the TCI state(s) in the list of TCI state(s) higher layer configured or provided to the UE, e.g., the joint/DL TCI state(s) provided or configured in/by DLorJointTCI-State-could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

In this case, the UE could first (implicitly) determine one or more candidate/actual new beam RSs or RS resources or RS resource configurations according to or following those described or specified in Case-VI such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations.

If the UE could identify or determine a L_min>1 number of candidate/actual new beam RS(s) or RS resource(s) or RS resource index(es)—out of the candidate/actual candidate/new beam RS(s)/RS resource(s)/RS resource index(es) determined or identified according to or following those described or specified in Case-VI—that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE (e.g., the UE 116) could (implicitly) determine one or more candidate/actual new beam RSs or RS resources or RS resource configurations according to or following those described or specified in Case-V such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations;

If the UE could identify or determine a L_min>1 number of candidate/actual new beam RS(s) or RS resource(s) or RS resource index(es)—out of the candidate/actual candidate/new beam RS(s)/RS resource(s)/RS resource index(es) determined or identified according to or following those described or specified in Case-V—that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could (implicitly) determine one or more candidate/actual new beam RSs or RS resources or RS resource configurations according to or following those described or specified in Case-VIII such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations;

If the UE could identify or determine a L_min>1 number of candidate/actual new beam RS(s) or RS resource(s) or RS resource index(es)—out of the candidate/actual candidate/new beam RS(s)/RS resource(s)/RS resource index(es) determined or identified according to or following those described or specified in Case-VIII—that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE could (implicitly) determine one or more candidate/actual new beam RSs or RS resources or RS resource configurations according to or following those described or specified in Case-VII such that the UE could assess or evaluate the radio link or beam quality(s)—e.g., by measuring L1-RSRP(s)/L1-SINR(s)—of the determined or identified one or more candidate/actual new beam RSs or RS resources or RS resource configurations;

If the UE could identify or determine a L_min>1 number of candidate/actual new beam RS(s) or RS resource(s) or RS resource index(es)—out of the candidate/actual candidate/new beam RS(s)/RS resource(s)/RS resource index(es) determined or identified according to or following those described or specified in Case-VII—that satisfies the event(s) condition(s) as specified/defined herein in the present disclosure, the UE could stop assessing or evaluating the radio link or beam quality(s)—e.g., by measuring L1-RSRP(s)/L1-SINR(s)—of the determined or identified candidate/actual new beam RS(s) or RS resource(s) or RS resource configuration(s), and may declare detection of or trigger the corresponding event(s); otherwise, the UE may not declare detection of or trigger the corresponding event(s).

Throughout the present disclosure and/or for the described/specified design examples herein in the present disclosure, the current serving beam RS(s)/RS resource(s)/RS resource index(es) and the candidate (or actual) candidate/new beam RS(s)/RS resource(s)/RS resource index(es) as specified/defined herein in the present disclosure could be in a/same set/list of RS(s) or RS resource(s) or RS resource index(es), e.g., provided or indicated or configured by the network via/by higher layer RRC signaling(s)/parameter(s) and/or MAC CE command(s) and/or dynamic DCI based L1 signaling(s) based on or according to a corresponding UE's capability or capability signaling. Optionally, the current serving beam RS(s)/RS resource(s)/RS resource index(es) and the candidate (or actual) candidate/new beam RS(s)/RS resource(s)/RS resource index(es) as specified/defined herein in the present disclosure could be in separate lists/sets of RSs or RS resources or RS resource indexes, e.g., provided or indicated or configured by the network (e.g., the network 130) via/by higher layer RRC signaling(s)/parameter(s) and/or MAC CE command(s) and/or dynamic DCI based L1 signaling(s) based on or according to a corresponding UE's capability or capability signaling.

The candidate or actual candidate/new beam RS(s) or RS resource(s) or RS resource (configuration) index(es) configured, determined or identified according to or following those specified herein in the present disclosure could comprise one or more CSI-RS resources, CSI-RS resource configurations and/or CSI-RS resource configuration indexes that could be QCL'ed (e.g., with QCL-TypeD) with a same SSB/SSB index or different/separate SSBs with different/separate SSB indexes. When/if the candidate or actual candidate/new beam RSs or RS resources or RS resource (configuration) indexes or RS indexes—comprising one or more CSI-RS resources, CSI-RS resource configurations and/or CSI-RS resource configuration indexes—are QCL'ed (e.g., with QCL-TypeD) with different SSBs having different SSB indexes.

In one example (configuration A), the bitwidth of a CSI-RS resource (configuration) index could be determined or provided or configured according to a/the total number of the candidate/actual candidate/new beam RSs/RS resources/RS resource indexes—and therefore the total number of the corresponding one or more CSI-RS resources/CSI-RS resource configurations/CSI-RS resource configuration indexes; denote by the total number as N_{csirs}, the bitwidth could be determined or provided or configured as ┌log₂N_{csirs}┐ bit(s). For this design example, for a CSI-RS, CSI-RS resource, CSI-RS resource configuration or CSI-RS resource configuration index as a candidate/actual candidate/new beam RS/RS resource/RS resource index, the UE could be indicated or provided or configured by the network, e.g., via/by higher layer RRC signaling(s)/parameter(s) and/or MAC CE command(s) and/or dynamic DCI based L1 signaling(s) based on or according to a corresponding UE's capability or capability signaling, information related to a SSB that could be QCL'ed (e.g., of QCL-TypeD) with the CSI-RS, CSI-RS resource, CSI-RS resource configuration or CSI-RS resource configuration index. For instance, the higher layer RRC signaling(s)/parameter(s) could correspond to or could be the higher layer RRC parameter(s) that configures or provides the corresponding CSI-RS, CSI-RS resource, CSI-RS resource configuration, CSI-RS resource configuration index, TCI state and/or etc. The higher layer RRC signaling(s)/parameter(s) could additionally be or could additionally correspond to CSI-ReportConfig, CSI-ResourceConfig, UEI-ReportConfig and/or UEI-ResourceConfig that provides or configures the corresponding UEI (beam) reporting. Furthermore, the information related to a SSB could be or could correspond to or comprise the SSB index provided by SSB-Index or index of the SSB among the configured/provided/determined/identified SSBs that could be QCL'ed (e.g., of QCL-TypeD) with the candidate/actual candidate/new beam RSs/RS resources/RS resource indexes as specified/defined herein in the present disclosure. The UE could be additionally indicated or provided or configured by the network, e.g., via/by RRC signaling(s)/parameter(s) and/or MAC CE command(s) and/or dynamic DCI based L1 signaling(s) based on or according to a corresponding UE's capability or capability signaling, a/the total number of candidate/actual candidate/new beam RSs/RS resources/RS resource indexes—and therefore the total number of the corresponding one or more CSI-RS resources/CSI-RS resource configurations/CSI-RS resource configuration indexes—that are QCL'ed (e.g., of QCL-TypeD) with each of the SSBs that could be QCL'ed (e.g., of QCL-TypeD) with the candidate/actual candidate/new beam RSs/RS resources/RS resource indexes as specified/defined herein in the present disclosure; note that the total number here could be identical or common for the SSBs or for each of the SSBs.

In another example (configuration-B), for a CSI-RS resource or CSI-RS resource configuration or CSI-RS QCL'ed (e.g., of QCL-TypeD) with a SSB, the bitwidth of the CSI-RS resource (configuration) index could be determined or provided or configured according to a/the total number of the candidate/actual candidate/new beam RSs/RS resources/RS resource indexes—and therefore the total number of the corresponding one or more CSI-RS resources/CSI-RS resource configurations/CSI-RS resource configuration indexes—that could be QCL'ed (e.g., of QCL-TypeD) with the same SSB; for a SSB with (SSB) index #k or the k-th SSB among the configured/provided/determined/identified SSBs that could be QCL'ed (e.g., of QCL-TypeD) with the candidate/actual candidate/new beam RSs/RS resources/RS resource indexes as specified/defined herein in the present disclosure, denote by the corresponding total number as N_{csirs},k, the bitwidth could be determined or provided or configured as ┌log₂N_{csirs,k}┐ bit(s). For this design example, for a CSI-RS, CSI-RS resource, CSI-RS resource configuration or CSI-RS resource configuration index as a candidate/actual candidate/new beam RS/RS resource/RS resource index, the UE could be indicated or provided or configured by the network, e.g., via/by higher layer RRC signaling(s)/parameter(s) and/or MAC CE command(s) and/or dynamic DCI based L1 signaling(s) based on or according to a corresponding UE's capability or capability signaling, information related to a SSB that could be QCL'ed (e.g., of QCL-TypeD) with the CSI-RS, CSI-RS resource, CSI-RS resource configuration or CSI-RS resource configuration index. For instance, the higher layer RRC signaling(s)/parameter(s) could correspond to or could be the higher layer RRC parameter(s) that configures or provides the corresponding CSI-RS, CSI-RS resource, CSI-RS resource configuration, CSI-RS resource configuration index, TCI state and/or etc. The higher layer RRC signaling(s)/parameter(s) could additionally be or could additionally correspond to CSI-ReportConfig, CSI-ResourceConfig, UEI-ReportConfig and/or UEI-ResourceConfig that provides or configures the corresponding UEI (beam) reporting. Furthermore, the information related to a SSB could be or could correspond to or comprise the SSB index provided by SSB-Index or index of the SSB among the configured/provided/determined/identified SSBs that could be QCL'ed (e.g., of QCL-TypeD) with the candidate/actual candidate/new beam RSs/RS resources/RS resource indexes as specified/defined herein in the present disclosure.

For configuration-A as described/specified herein in the present disclosure, a/the UEI (beam) report could comprise one or more CRIs each corresponding to a candidate/actual candidate/new beam RS or RS resource or RS resource index-hence the corresponding CSI-RS or CSI-RS resource or CSI-RS resource (configuration) index; in this case, the bitwidth of each of the reported CRIs in the UEI beam report could be ┌log₂N_{csirs}┐ bit(s). For configuration-B as described/specified herein in the present disclosure, a/the UEI (beam) report could comprise one or more CRIs each corresponding to a candidate/actual candidate/new beam RS or RS resource or RS resource index-hence the corresponding CSI-RS or CSI-RS resource or CSI-RS resource (configuration) index; in this case, the bitwidth of a reported CRI in the UEI beam report could be ┌log₂N_{csirs,k}┐ bit(s) when/if the reported CRI corresponds to a candidate/actual candidate/new beam RS or RS resource or RS resource index-hence the corresponding CSI-RS or CSI-RS resource or CSI-RS resource (configuration) index—that is QCL'ed (e.g., of QCL-TypeD) with the SSB with (SSB) index #k or the k-th SSB among the configured/provided/determined/identified SSBs that could be QCL'ed (e.g., of QCL-TypeD) with the candidate/actual candidate/new beam RSs/RS resources/RS resource indexes as specified/defined herein in the present disclosure; in this case, the (same) UEI (beam) report could also comprise a SSBRI (e.g., SSBRI k)—associated to the reported CRI—corresponding to the SSB with (SSB) index #k or the k-th SSB among the configured/provided/determined/identified SSBs that could be QCL'ed (e.g., of QCL-TypeD) with the candidate/actual candidate/new beam RSs/RS resources/RS resource indexes as specified/defined herein in the present disclosure.

Optionally, a/the UE could be indicated or provided or configured by the network, e.g., via/by higher layer RRC signaling(s)/parameter(s) and/or MAC CE command(s) and/or dynamic DCI based L1 signaling(s) based on or according to a corresponding UE's capability or capability signaling, one or more Type-A indicators to indicate whether the candidate or actual candidate/new beam RS(s) or RS resource(s) or RS resource (configuration) index(es) configured, determined or identified according to or following those specified herein in the present disclosure comprising one or more CSI-RS resources, CSI-RS resource configurations and/or CSI-RS resource configuration indexes is QCL'ed (e.g., with QCL-TypeD) with a same SSB/SSB index or different/separate SSBs with different/separate SSB indexes. For example, the higher layer RRC signaling(s)/parameter(s) could be or could correspond to the higher layer RRC parameter(s) that provides or configures the candidate or actual candidate/new beam RS(s) or RS resource(s) or RS resource (configuration) index(es)—i.e., the corresponding CSI-RS, CSI-RS resource, CSI-RS resource configuration or CSI-RS resource (configuration) index in this case-TCI state(s) and/or etc. For another example, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. Furthermore, the one or more Type-A indicators could be or could correspond to a one-bit indicator. In this case, when/if the Type-A indicator(s), e.g., the one-bit indicator, is present/configured/enabled and/or set to ‘1’ (or ‘0’) or ‘enabled’ or ‘on’ or ‘differentSSBs’, the UE could determine or identify that the candidate or actual candidate/new beam RS(s) or RS resource(s) or RS resource (configuration) index(es) configured, determined or identified according to or following those specified herein in the present disclosure comprising one or more CSI-RS resources, CSI-RS resource configurations and/or CSI-RS resource configuration indexes could be QCL'ed (e.g., with QCL-TypeD) with different/separate SSBs with different/separate SSB indexes; otherwise, i.e., when/if the Type-A indicator(s), e.g., the one-bit indicator, is absent/not present or configured or enabled, and/or is present/configured/enabled and set to ‘0’ (or ‘1’) or ‘disabled’ or ‘off’ or ‘sameSSB’, the UE could determine or identify that the candidate or actual candidate/new beam RS(s) or RS resource(s) or RS resource (configuration) index(es) configured, determined or identified according to or following those specified herein in the present disclosure comprising one or more CSI-RS resources, CSI-RS resource configurations and/or CSI-RS resource configuration indexes could be QCL'ed (e.g., with QCL-TypeD) with a same SSB/SSB index.

As specified/discussed herein in the present disclosure, a current serving beam RS/RS index/RS resource/RS resource index could be determined according to or as the RS(s), RS resource(s) or RS resource index(es)—e.g., CSI-RS(s), CSI-RS resource(s) or CSI-RS resource configuration index(es) including TRS(s)—provided in an indicated TCI state (e.g., according to or following those specified in the implicit determination example-1 in the present disclosure), and/or determined according to or as the SSB(s) or SSB index(es) that could be QCL'ed (e.g., of QCL-TypeD) with the RS(s), RS resource(s) or RS resource index(es)—e.g., CSI-RS(s), CSI-RS resource(s) or CSI-RS resource configuration index(es) including TRS(s)—provided in an indicated TCI state (e.g., according to or following those specified in the implicit determination example-2 in the present disclosure), and/or according to or as the CSI-RS(s), CSI-RS resource(s) or CSI-RS resource configuration index(es) including TRS(s) provided/configured in the set s̅₀ (e.g., according to or following those specified in the explicit configuration example-1 in the present disclosure), and/or according to or as the SSB(s) or SSB index(es) provided/configured in the set \vec{s}₀ (e.g., according to or following those specified in the explicit configuration example-2 in the present disclosure). The UE could be configured or indicated or provided by the network, e.g., via higher layer RRC signalling(s)/parameter(s) and/or MAC CE command(s) and/or dynamic DCI based L1 signaling(s) based on or according to a corresponding UE's capability or capability signalling, one or more Type-B indicators to indicate whether a/the UE could determine or identify a current serving beam RS/RS index/RS resource/RS resource index according to or as (1) a CSI-RS, CSI-RS resource or CSI-RS resource configuration index including TRS, e.g., according to or following those specified in the implicit determination example-1 and/or the explicit configuration example-1 as described/specified herein in the present disclosure, and/or (2) a SSB or SSB index, e.g., according to or following those specified in the implicit determination example-2 and/or the explicit configuration example-2 as described/specified herein in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-B indicators could be or could correspond to a one-bit indicator or a multi-bit (e.g., 2-bit) indicator.

In one example, a/the UE could determine or identify a first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, as a/the baseline or default setting. For this design example, the UE could be configured or indicated or provided or instructed or informed by the network, e.g., via higher layer RRC signalling(s)/parameter(s) and/or MAC CE command(s) and/or dynamic DCI based L1 signaling(s) based on or according to a corresponding UE's capability or capability signalling, one or more Type-C indicators to indicate to the UE whether the UE would need to determine or identify an additional current serving beam RS/RS index/RS resource/RS resource index—denoted by a second current serving beam RS/RS index/RS resource/RS resource index-according to or as a SSB or SSB index, e.g., according to or following those specified in the implicit determination example-2 and/or the explicit configuration example-2 as described/specified herein in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-C indicators could be or could correspond to a one-bit indicator or a multi-bit (e.g., 2-bit) indicator. That is,
Regardless of whether the Type-C indicator(s) is present (or absent) or configured (or not configured) or provided (or not provided) or enabled (or disabled or not enabled) or set (or not set) to valid (or invalid) value(s) including ‘0’ or ‘1’ or ‘00’ or ‘01’ or ‘10’ or ‘11’ or ‘on’ or ‘off’ or ‘enabled’ or ‘disabled’ or ‘default’ in the corresponding higher layer RRC signaling(s)/parameter(s) and/or MAC CE command(s) and/or dynamic DCI based L1 signaling(s), and/or when/if the Type-C indicator(s) is present or configured or provided or set to valid (or invalid) value(s) in the corresponding higher layer RRC signaling(s)/parameter(s) and/or MAC CE command(s) and/or dynamic DCI based L1 signaling(s) and regardless of the value(s) of the Type-C indicator(s), a/the UE could determine or identify a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; and/or
when/if the Type-C indicator(s) is not present or absent or not configured or not provided or not enabled or disabled or set to invalid value(s) or not set to valid value(s) including ‘0’ or ‘1’ or ‘00’ or ‘01’ or ‘10’ or ‘1l’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if the UE determines or identifies that the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure (specifically, for the explicit configuration example-B, the set s̅₁ of SSBs/SSB indexes as defined/specified herein in the present disclosure is provide or configured or indicated by the network), the UE is expected to or the UE could determine or identify a/the additional second current serving beam RS/RS index/RS resource/RS resource index according to or as a SSB or SSB index, e.g., according to or following those specified in the implicit determination example-2 and/or the explicit configuration example-2 as described/specified herein in the present disclosure; and/or
when/if the Type-C indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if a/the second threshold Th_ssb as defined/specified herein in the present disclosure is provide or configured or indicated by the network according to or following those described/specified herein in the present disclosure, the UE is expected to or the UE could determine or identify a/the additional second current serving beam RS/RS index/RS resource/RS resource index according to or as a SSB or SSB index, e.g., according to or following those specified in the implicit determination example-2 and/or the explicit configuration example-2 as described/specified herein in the present disclosure; and/or
when/if the Type-C indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if the one or more RSs/RS resources/RS resource indexes provided in/by the indicated TCI state (e.g., of QCL-TypeD)—e.g., as specified in the implicit determination example-1-correspond to CSI-RS(s) for tracking or tracking reference signal(s)—e.g., CSI-RS(s) configured with trs-Info, the UE is expected to or the UE could determine or identify a/the additional second current serving beam RS/RS index/RS resource/RS resource index according to or as a SSB or SSB index, e.g., according to or following those specified in the implicit determination example-2 and/or the explicit configuration example-2 as described/specified herein in the present disclosure; and/or
when/if the Type-C indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE is not expected to or the UE would not determine or identify a/the additional second current serving beam RS/RS index/RS resource/RS resource index according to or as a SSB or SSB index, e.g., according to or following those specified in the implicit determination example-2 and/or the explicit configuration example-2 as described/specified herein in the present disclosure; and/or
when/if the Type-C indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE is expected to or the UE could determine or identify a/the additional second current serving beam RS/RS index/RS resource/RS resource index according to or as a SSB or SSB index, e.g., according to or following those specified in the implicit determination example-2 and/or the explicit configuration example-2 as described/specified herein in the present disclosure.

That is, a/the UE could determine or identify a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, and whether or not a/the UE (e.g., the UE 116) could determine or identify a/the second current serving beam RS/RS index/RS resource/RS resource index—in addition to the first current serving beam RS/RS index/RS resource/RS resource index as specified/defined herein in the present disclosure-according to or as a SSB or SSB index, e.g., according to or following those specified in the implicit determination example-2 and/or the explicit configuration example-2 as described/specified herein in the present disclosure could be based on network's configuration(s)/indication(s) according to a corresponding UE's capability or capability signaling. In this case,
When/if the Type-C indicator(s) as specified/defined herein in the present disclosure is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising only CRI(s) and the associated/corresponding beam metric(s) including L1-RSRP(s)/L1-SINR(s).
Otherwise, i.e., when/if the Type-C indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising:
   Format-A: only CRI(s) and the corresponding beam metric(s) including L1-RSRP(s)/L1-SINR(s)
   Format-B: only SSBRI(s) and the corresponding beam metric(s) including L1-RSRP(s)/L1-SINR(s)
   Format-C: a mixture of both CRI(s) and SSBRI (s) and their corresponding beam metric(s) including L1-RSRP(s)/L1-SINR(s)

Optionally, the UE could indicate to the network, e.g., via one or more indicators provided by/in part of the UEI beam report, which one or more of the Format-A, Format-B and Format-C as defined/discussed/specified herein the UE has applied or used to construct the corresponding UEI beam report(s). For example, the one or more indicators could be or could correspond to a one-bit indicator: when/if the one-bit indicator is set to ‘0’ (or ‘1’), it could indicate that the Format-A (or the Format-C) is used by the UE, and when/if the one-bit indicator is set to ‘0’ (or ‘1’), it could indicate that the Format-B (or the Format-C) is used by the UE. For another example, the one or more indicators could be or could correspond to a 2-bit indicator: when/if the 2-bit indicator is set to ‘00’ (or ‘01’ or ‘10’ or ‘11’), it could indicate that the Format-A is used by the UE, when/if the 2-bit indicator is set to ‘01’ (or ‘00’ or ‘10’ or ‘11’), it could indicate that the Format-B is used, and when/if the 2-bit indicator is set to ‘10’ or ‘11’ (or ‘00’ or ‘01’), it could indicate that the Format-C is used.

In another example, a/the UE could determine or identify a first current serving beam RS/RS index/RS resource/RS resource index according to or as according to or as a SSB or SSB index, e.g., according to or following those specified in the implicit determination example-2 and/or the explicit configuration example-2 as described/specified herein in the present disclosure, as a/the baseline or default setting. For this design example, the UE could be configured or indicated or provided or instructed or informed by the network (e.g., the network 130), e.g., via higher layer RRC signalling(s)/parameter(s) and/or MAC CE command(s) and/or dynamic DCI based L1 signaling(s) based on or according to a corresponding UE's capability or capability signalling, one or more Type-D indicators to indicate to the UE whether the UE would need to determine or identify an additional current serving beam RS/RS index/RS resource/RS resource index-denoted by a second current serving beam RS/RS index/RS resource/RS resource index-according to or as a CSI-RS, CSI-RS resource or CSI-RS resource configuration index including TRS, e.g., according to or following those specified in the implicit determination example-1 and/or the explicit configuration example-1 as described/specified herein in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-D indicators could be or could correspond to a one-bit indicator or a multi-bit (e.g., 2-bit) indicator. That is,
Regardless of whether the Type-D indicator(s) is present (or absent) or configured (or not configured) or provided (or not provided) or enabled (or disabled or not enabled) or set (or not set) to valid (or invalid) value(s) including ‘0’ or ‘1’ or ‘00’ or ‘01’ or ‘10’ or ‘11’ or ‘on’ or ‘off’ or ‘enabled’ or ‘disabled’ or ‘default’ in the corresponding higher layer RRC signaling(s)/parameter(s) and/or MAC CE command(s) and/or dynamic DCI based L1 signaling(s), and/or when/if the Type-D indicator(s) is present or configured or provided or set to valid (or invalid) value(s) in the corresponding higher layer RRC signaling(s)/parameter(s) and/or MAC CE command(s) and/or dynamic DCI based L1 signaling(s) and regardless of the value(s) of the Type-D indicator(s), a/the UE could determine or identify a/the first current serving beam RS/RS index/RS resource/RS resource index according to or as according to or as a SSB or SSB index, e.g., according to or following those specified in the implicit determination example-2 and/or the explicit configuration example-2 as described/specified herein in the present disclosure; and/or
when/if the Type-D indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if the UE determines or identifies that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure (specifically, for the explicit configuration example-A, the set s̅₁ of (periodic) CSI-RS resource configuration indexes as defined/specified herein in the present disclosure is provide or configured or indicated by the networker), the UE is expected to or the UE could determine or identify a/the additional second current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; and/or
when/if the Type-D indicator(s) is not present or absent or not configured or not provided or not enabled or disabled or set to invalid value(s) or not set to valid value(s) including ‘0’ or ‘1’ or ‘00’ or ‘01’ or ‘10’ or ‘1l’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if a/the first threshold Th_csirs as defined/specified herein in the present disclosure is provide or configured or indicated by the network according to or following those described/specified herein in the present disclosure, the UE is expected to or the UE could determine or identify a/the additional second current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; and/or
when/if the Type-D indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) in the corresponding higher layer RRC signaling(s)/parameter(s) and/or MAC CE command(s) and/or dynamic DCI based L1 signaling(s), and/or when/if the one or more RSs/RS resources/RS resource indexes provided in/by the indicated TCI state (e.g., of QCL-TypeD)—e.g., as specified in the implicit determination example-1-correspond to CSI-RS(s) for beam management—e.g., CSI-RS(s) configured with repetition or with repetition set to ‘on’, the UE is expected to or the UE could determine or identify a/the additional second current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; and/or
when/if the Type-D indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE is not expected to or the UE would not determine or identify a/the additional second current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; and/or
when/if the Type-D indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE is expected to or the UE could determine or identify a/the additional second current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure.

That is, a/the UE could determine or identify a/the first current serving beam RS/RS index/RS resource/RS resource index according to or as a SSB or SSB index, e.g., according to or following those specified in the implicit determination example-2 and/or the explicit configuration example-2 as described/specified herein in the present disclosure, and whether or not a/the UE could determine or identify a/the second current serving beam RS/RS index/RS resource/RS resource index—in addition to the first current serving beam RS/RS index/RS resource/RS resource index as specified/defined herein in the present disclosure—according to or as a CSI-RS, CSI-RS resource or CSI-RS resource configuration index including TRS, e.g., according to or following those specified in the implicit determination example-1 and/or the explicit configuration example-1 as described/specified herein in the present disclosure could be based on network's configuration(s)/indication(s) according to a corresponding UE's capability or capability signaling. In this case,
When/if the Type-D indicator(s) as specified/defined herein in the present disclosure is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising only SSBRI(s) and the associated/corresponding beam metric(s) including L1-RSRP(s)/L1-SINR(s).
Otherwise, i.e., when/if the Type-D indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising:
   Format-A: only CRI(s) and the corresponding beam metric(s) including L1-RSRP(s)/L1-SINR(s)
   Format-B: only SSBRI(s) and the corresponding beam metric(s) including L1-RSRP(s)/L1-SINR(s)
   Format-C: a mixture of both CRI(s) and SSBRI(s) and their corresponding beam metric(s) including L1-RSRP(s)/L1-SINR(s)

Optionally, the UE could indicate to the network, e.g., via one or more indicators provided by/in part of the UEI beam report, which one or more of the Format-A, Format-B and Format-C as defined/discussed/specified herein the UE has applied or used to construct the corresponding UEI beam report(s). For example, the one or more indicators could be or could correspond to a one-bit indicator: when/if the one-bit indicator is set to ‘0’ (or ‘1’), it could indicate that the Format-A (or the Format-C) is used by the UE, and when/if the one-bit indicator is set to ‘0’ (or ‘1’), it could indicate that the Format-B (or the Format-C) is used by the UE. For another example, the one or more indicators could be or could correspond to a 2-bit indicator: when/if the 2-bit indicator is set to ‘00’ (or ‘01’ or ‘10’ or ‘11’), it could indicate that the Format-A is used by the UE, when/if the 2-bit indicator is set to ‘01’ (or ‘00’ or ‘10’ or ‘11’), it could indicate that the Format-B is used, and when/if the 2-bit indicator is set to ‘10’ or ‘11’ (or ‘00’ or ‘01’), it could indicate that the Format-C is used.

In another example, a/the UE could determine or identify a first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, and a second current serving beam RS/RS index/RS resource/RS resource index according to or as according to or as a SSB or SSB index, e.g., according to or following those specified in the implicit determination example-2 and/or the explicit configuration example-2 as described/specified herein in the present disclosure, as a/the baseline or default setting. For this design example, the UE could be configured or indicated or provided or instructed or informed by the network, e.g., via higher layer RRC signalling(s)/parameter(s) and/or MAC CE command(s) and/or dynamic DCI based L1 signaling(s) based on or according to a corresponding UE's capability or capability signalling, one or more Type-E indicators to indicate to the UE whether the UE would only need to determine or identify the current serving beam RS/RS index/RS resource/RS resource index according to or as (i) the first current serving beam RS/RS index/RS resource/RS resource index-according to or as a CSI-RS, CSI-RS resource or CSI-RS resource configuration index including TRS, e.g., according to or following those specified in the implicit determination example-1 and/or the explicit configuration example-1 as described/specified herein in the present disclosure, or (ii) the second current serving beam RS/RS index/RS resource/RS resource index-according to or as according to or as a SSB or SSB index, e.g., according to or following those specified in the implicit determination example-2 and/or the explicit configuration example-2 as described/specified herein in the present disclosure; i.e., the Type-E indicator(s) here could indicate to the UE not to determine or identify one of or to determine or identify the current serving beam RS/RS index/RS resource/RS resource index not according to or as one of (i) the first current serving beam RS/RS index/RS resource/RS resource index-according to or as a CSI-RS, CSI-RS resource or CSI-RS resource configuration index including TRS, e.g., according to or following those specified in the implicit determination example-1 and/or the explicit configuration example-1 as described/specified herein in the present disclosure and (ii) the second current serving beam RS/RS index/RS resource/RS resource index-according to or as according to or as a SSB or SSB index, e.g., according to or following those specified in the implicit determination example-2 and/or the explicit configuration example-2 as described/specified herein in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. The one or more Type-E indicators could be or could correspond to a one-bit indicator or a multi-bit (e.g., 2-bit) indicator. That is,
when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE would determine or identify two current serving beam RSs/RS indexes/RS resources/RS resource indexes respectively corresponding to the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, and the second current serving beam RS/RS index/RS resource/RS resource index according to or as according to or as a SSB or SSB index, e.g., according to or following those specified in the implicit determination example-2 and/or the explicit configuration example-2 as described/specified herein in the present disclosure; and/or
when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s), and/or when/if the UE determines or identifies that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure (specifically, for the explicit configuration example-A, the set s̅₁ of (periodic) CSI-RS resource configuration indexes as defined/specified herein in the present disclosure is provide or configured or indicated by the networker), the UE is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; i.e., the UE would not determine or identify any SSB(s) or SSB index(es), e.g., according to or following those specified in the implicit determination example-2 and/or the explicit configuration example-2 as described/specified herein in the present disclosure, as a current serving beam RS/RS index/RS resource/RS resource index; and/or
when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s), when/if the UE determines or identifies that the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure (specifically, for the explicit configuration example-B, the set s̅₁ of SSBs/SSB indexes as defined/specified herein in the present disclosure is provide or configured or indicated by the network), the UE is expected to or the UE could (only) determine or identify the current serving beam RS/RS index/RS resource/RS resource index as a/the second current serving beam RS/RS index/RS resource/RS resource index according to or as a SSB or SSB index, e.g., according to or following those specified in the implicit determination example-2 and/or the explicit configuration example-2 as described/specified herein in the present disclosure; i.e., UE would not determine or identify any CSI-RS(s), CSI-RS resource(s) or CSI-RS resource configuration index(es) including TRS(s), e.g., according to or following those specified in the implicit determination example-1 and/or the explicit configuration example-1 as described/specified herein in the present disclosure, as a current serving beam RS/RS index/RS resource/RS resource index; and/or
when/if the Type-E indicator(s) is not present or absent or not configured or not provided or not enabled or disabled or set to invalid value(s) or not set to valid value(s) including ‘0’ or ‘l’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s), and/or when/if a/the second threshold Th_ssb as defined/specified herein in the present disclosure is provide or configured or indicated by the network according to or following those described/specified herein in the present disclosure, the UE is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; i.e., the UE would not determine or identify any SSB(s) or SSB index(es), e.g., according to or following those specified in the implicit determination example-2 and/or the explicit configuration example-2 as described/specified herein in the present disclosure, as a current serving beam RS/RS index/RS resource/RS resource index; and/or
when/if the Type-E indicator(s) is not present or absent or not configured or not provided or not enabled or disabled or set to invalid value(s) or not set to valid value(s) including ‘0’ or ‘l’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s), when/if the second threshold Th_ssb as defined/specified herein in the present disclosure is provide or configured or indicated by the network according to or following those described/specified herein in the present disclosure, the UE is expected to or the UE could (only) determine or identify the current serving beam RS/RS index/RS resource/RS resource index as a/the second current serving beam RS/RS index/RS resource/RS resource index according to or as a SSB or SSB index, e.g., according to or following those specified in the implicit determination example-2 and/or the explicit configuration example-2 as described/specified herein in the present disclosure; i.e., UE would not determine or identify any CSI-RS(s), CSI-RS resource(s) or CSI-RS resource configuration index(es) including TRS(s), e.g., according to or following those specified in the implicit determination example-1 and/or the explicit configuration example-1 as described/specified herein in the present disclosure, as a current serving beam RS/RS index/RS resource/RS resource index; and/or
when/if the Type-E indicator(s) is not present or absent or not configured or not provided or not enabled or disabled or set to invalid value(s) or not set to valid value(s) including ‘0’ or ‘l’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s), and/or when/if the one or more RSs/RS resources/RS resource indexes provided in/by the indicated TCI state (e.g., of QCL-TypeD)—e.g., as specified in the implicit determination example-1-correspond to CSI-RS(s) for beam management—e.g., CSI-RS(s) configured with repetition or with repetition set to ‘on’, the UE (e.g., the UE 116) is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; i.e., the UE would not determine or identify any SSB(s) or SSB index(es), e.g., according to or following those specified in the implicit determination example-2 and/or the explicit configuration example-2 as described/specified herein in the present disclosure, as a current serving beam RS/RS index/RS resource/RS resource index; and/or
when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s), and/or when/if the one or more RSs/RS resources/RS resource indexes provided in/by the indicated TCI state (e.g., of QCL-TypeD)—e.g., as specified in the implicit determination example-1—correspond to CSI-RS(s) for tracking or tracking reference signal(s)—e.g., CSI-RS(s) configured with trs-Info, the UE is expected to or the UE could (only) determine or identify the current serving beam RS/RS index/RS resource/RS resource index as a/the second current serving beam RS/RS index/RS resource/RS resource index according to or as a SSB or SSB index, e.g., according to or following those specified in the implicit determination example-2 and/or the explicit configuration example-2 as described/specified herein in the present disclosure; i.e., UE would not determine or identify any CSI-RS(s), CSI-RS resource(s) or CSI-RS resource configuration index(es) including TRS(s), e.g., according to or following those specified in the implicit determination example-1 and/or the explicit configuration example-1 as described/specified herein in the present disclosure, as a current serving beam RS/RS index/RS resource/RS resource index; and/or
when/if the Type-E indicator(s) is present or configured or provided or enabled or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s), the UE is expected to or the UE could (only) determine or identify the current serving beam RS/RS index/RS resource/RS resource index as a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure; i.e., the UE would not determine or identify any SSB(s) or SSB index(es), e.g., according to or following those specified in the implicit determination example-2 and/or the explicit configuration example-2 as described/specified herein in the present disclosure, as a current serving beam RS/RS index/RS resource/RS resource index; and/or
when/if the Type-E indicator(s) is present or configured or provided or enabled or set to valid value(s) including ‘0’ (or ‘1’) or ‘00’ (or ‘01’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s), the UE is expected to or the UE could (only) determine or identify the current serving beam RS/RS index/RS resource/RS resource index as a/the second current serving beam RS/RS index/RS resource/RS resource index according to or as a SSB or SSB index, e.g., according to or following those specified in the implicit determination example-2 and/or the explicit configuration example-2 as described/specified herein in the present disclosure; i.e., UE would not determine or identify any CSI-RS(s), CSI-RS resource(s) or CSI-RS resource configuration index(es) including TRS(s), e.g., according to or following those specified in the implicit determination example-1 and/or the explicit configuration example-1 as described/specified herein in the present disclosure, as a current serving beam RS/RS index/RS resource/RS resource index.

That is, by default, a/the UE could determine or identify a first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, and a second current serving beam RS/RS index/RS resource/RS resource index according to or as according to or as a SSB or SSB index, e.g., according to or following those specified in the implicit determination example-2 and/or the explicit configuration example-2 as described/specified herein in the present disclosure, and whether or not a/the UE could (only) determine or identify the current serving beam RS/RS index/RS resource/RS resource index as (i) a/the first current serving beam RS/RS index/RS resource/RS resource index according to or as a CSI-RS, CSI-RS resource or CSI-RS resource configuration index including TRS, e.g., according to or following those specified in the implicit determination example-1 and/or the explicit configuration example-1 as described/specified herein in the present disclosure, or (ii) a/the second current serving beam RS/RS index/RS resource/RS resource index according to or as a SSB or SSB index, e.g., according to or following those specified in the implicit determination example-2 and/or the explicit configuration example-2 as described/specified herein in the present disclosure could be based on network's configuration(s)/indication(s) according to a corresponding UE's capability or capability signaling. In this case,
When/if the Type-E indicator(s) as specified/defined herein in the present disclosure is present or configured or provided or enabled or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s), the UE could send or transmit to the network (e.g., the network 130), in a CSI-Report or reporting instance, a UEI beam report comprising only CRI(s) and the associated/corresponding beam metric(s) including L1-RSRP(s)/L1-SINR(s); and/or
When/if the Type-E indicator(s) as specified/defined herein in the present disclosure is present or configured or provided or enabled or set to valid value(s) including ‘0’ (or ‘1’) or ‘00’ (or ‘01’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising only SSBRI(s) and the associated/corresponding beam metric(s) including L1-RSRP(s)/L1-SINR(s);
Otherwise, i.e., when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s), the UE could send or transmit to the network, in a CSI-Report or reporting instance, a UEI beam report comprising:
   Format-A: only CRI(s) and the corresponding beam metric(s) including L1-RSRP(s)/L1-SINR(s)
   Format-B: only SSBRI(s) and the corresponding beam metric(s) including L1-RSRP(s)/L1-SINR(s)
   Format-C: a mixture of both CRI(s) and SSBRI (s) and their corresponding beam metric(s) including L1-RSRP(s)/L1-SINR(s)

Optionally, the UE could indicate to the network, e.g., via one or more indicators provided by/in part of the UEI beam report, which one or more of the Format-A, Format-B and Format-C as defined/discussed/specified herein the UE has applied or used to construct the corresponding UEI beam report(s). For example, the one or more indicators could be or could correspond to a one-bit indicator: when/if the one-bit indicator is set to ‘0’ (or ‘1’), it could indicate that the Format-A (or the Format-C) is used by the UE, and when/if the one-bit indicator is set to ‘0’ (or ‘1’), it could indicate that the Format-B (or the Format-C) is used by the UE. For another example, the one or more indicators could be or could correspond to a 2-bit indicator: when/if the 2-bit indicator is set to ‘00’ (or ‘01’ or ‘10’ or ‘11’), it could indicate that the Format-A is used by the UE, when/if the 2-bit indicator is set to ‘01’ (or ‘00’ or ‘10’ or ‘11’), it could indicate that the Format-B is used, and when/if the 2-bit indicator is set to ‘10’ or ‘11’ (or ‘00’ or ‘01’), it could indicate that the Format-C is used.

For the report Format-C as described/specified herein in the present disclosure, the UE could also indicate or transmit or send to the network, e.g., by/in part of the (same) UEI beam report, one or more indicators (e.g., a bitmap, one or more 1-bit (flag) indicators, etc.) to indicate which one or more of the CSI field(s) or entries in the UEI beam report is used to carry or convey the SSBRI(s)—and therefore the corresponding beam metric(s) including L1-RSRP(s)/L1-SINR(s), or the CRI(s)—and therefore the corresponding beam metric(s) including L1-RSRP(s)/L1-SINR(s). Optionally, which one or more of the CSI field(s) or entries in the UEI beam report is used to carry or convey the SSBRI(s)—and therefore the corresponding beam metric(s) including L1-RSRP(s)/L1-SINR(s), or the CRI(s)—and therefore the corresponding beam metric(s) including L1-RSRP(s)/L1-SINR(s) could be determined according to fixed rule(s)/ordering(s) provided in the system specification(s) or per RRC (re) configuration.

In one example (example-I), a/the UE could determine or identify a current serving beam RS/RS index/RS resource/RS resource index according to or as a (periodic) CSI-RS, CSI-RS resource or CSI-RS resource configuration index including TRS, e.g., according to or following those specified in the implicit determination example-1 and/or the explicit configuration example-1 as described/specified herein in the present disclosure, and/or the UE could determine or identify that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure, when/if one or more of the following conditions are achieved or satisfied.
Condition-A: the Type-A indicator(s), e.g., the one-bit indicator, as specified/defined herein in the present disclosure is present/configured/enabled and/or set to ‘1’ (or ‘0’) or ‘enabled’ or ‘on’ or ‘differentSSBs’;
Condition-B: the Type-B indicator(s), e.g., a one-bit, two-bit or multi-bit indicator, as specified/defined herein in the present disclosure is present/configured/enabled and/or set to ‘1’ (or ‘0’) or ‘00’ (or ‘01’, ‘10’ or ‘11’) or ‘enabled’ (or ‘disabled’) or ‘on’ (or ‘off’) or ‘csirsAsCurrentBeam’
Condition-C: the UE determines or identifies that the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure; specifically, for the explicit configuration example-A, the set s̅₁ of (periodic) CSI-RS resource configuration indexes as defined/specified herein in the present disclosure is provide or configured or indicated by the network
Condition-DO: the set s̅₀ of (periodic) CSI-RS resource configuration indexes as defined/specified herein in the present disclosure (explicit configuration example-1) is provide or configured or indicated by the network
Condition-D1: regardless of whether the Type-C indicator(s) is present (or absent) or configured (or not configured) or provided (or not provided) or enabled (or disabled or not enabled) or set (or not set) to valid (or invalid) value(s) including ‘0’ or ‘l’ or ‘00’ or ‘01’ or ‘10’ or ‘1l’ or ‘on’ or ‘off’ or ‘enabled’ or ‘disabled’ or ‘default’ in the corresponding higher layer RRC signaling(s)/parameter(s) and/or MAC CE command(s) and/or dynamic DCI based L1 signaling(s), and/or when/if the Type-C indicator(s) is present or configured or provided or set to valid (or invalid) value(s) in the corresponding higher layer RRC signaling(s)/parameter(s) and/or MAC CE command(s) and/or dynamic DCI based L1 signaling(s) and regardless of the value(s) of the Type-C indicator(s)
Condition-D2: when/if the Type-D indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE could send or transmit to the network
Condition-D3: when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s)
Condition-D4: when/if the Type-E indicator(s) is present or configured or provided or enabled or set to valid value(s) including ‘1’ (or ‘0’) or ‘01’ (or ‘00’ or ‘10’ or ‘11’) or ‘on’ (or ‘off’) or ‘enabled’ (or ‘disabled’) or ‘csirsAsCurrentBeam’ in the corresponding higher layer RRC signaling(s)/parameter(s) and/or MAC CE command(s) and/or dynamic DCI based L1 signaling(s)
Condition-D5: when/if the one or more RSs/RS resources/RS resource indexes provided in/by the indicated TCI state (e.g., of QCL-TypeD)—e.g., as specified in the implicit determination example-1-correspond to CSI-RS(s) for beam management—e.g., CSI-RS(s) configured with repetition or with repetition set to ‘on’

For this design example (i.e., the example-I), the UE could send or transmit to the network a/the UEI beam report, in a reporting instance, comprising one or more CRIs—and therefore, the corresponding beam metric(s) including L1-RSRP(s)/L1-SINR(s)—each corresponding to a CSI-RS/CSI-RS resource/CSI-RS resource configuration/CSI-RS resource configuration index (as a current serving beam RS/RS resource/RS resource index or a candidate/actual new beam RS/RS resource/RS resource index in this design example that satisfies the event(s) condition(s) as defined/specified herein in the present disclosure).

In one example (example-II), a/the UE could determine or identify a current serving beam RS/RS index/RS resource/RS resource index according to or as a SSB or SSB index, e.g., according to or following those specified in the implicit determination example-2 and/or the explicit configuration example-2 as described/specified herein in the present disclosure, and/or the UE could determine or identify that the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure, when/if one or more of the following conditions are achieved or satisfied.
Condition-E: the Type-A indicator(s), e.g., the one-bit indicator, as specified/defined herein in the present disclosure is absent/not present or configured or enabled, and/or is present/configured/enabled and set to ‘0’ (or ‘1’) or ‘disabled’ or ‘off’ or ‘sameSSB’;
Condition-F: the Type-B indicator(s), e.g., a one-bit, two-bit or multi-bit indicator, as specified/defined herein in the present disclosure is present/configured/enabled and/or set to ‘0’ (or ‘1’) or ‘01’ (or ‘00’, ‘10’ or ‘11’) or ‘disabled’ (or ‘enabled’) or ‘off’ (or ‘on’) or ‘ssbAsCurrentBeam’
Condition-G: the UE determines or identifies that the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure; specifically, for the explicit configuration example-B, the set s̅₁ of SSBs/SSB indexes as defined/specified herein in the present disclosure is provide or configured or indicated by the network
Condition-H0: the set s̅₀ of SSBs/SSB indexes as defined/specified herein in the present disclosure (explicit configuration example-2) is provide or configured or indicated by the network
Condition-H1: when/if the Type-C indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s)
Condition-H2: regardless of whether the Type-D indicator(s) is present (or absent) or configured (or not configured) or provided (or not provided) or enabled (or disabled or not enabled) or set (or not set) to valid (or invalid) value(s) including ‘0’ or ‘1’ or ‘00’ or ‘01’ or ‘10’ or ‘11’ or ‘on’ or ‘off’ or ‘enabled’ or ‘disabled’ or ‘default’ in the corresponding higher layer RRC signaling(s)/parameter(s) and/or MAC CE command(s) and/or dynamic DCI based L1 signaling(s)
Condition-H3: when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s)
Condition-H4: when/if the Type-E indicator(s) is present or configured or provided or enabled or set to valid value(s) including ‘0’ (or ‘1’) or ‘00’ (or ‘01’ or ‘10’ or ‘11’) or ‘off’ (or ‘on’) or ‘disabled’ (or ‘enabled’) or ‘ssbAsCurrentBeam’ in the corresponding higher layer RRC signaling(s)/parameter(s) and/or MAC CE command(s) and/or dynamic DCI based L1 signaling(s)
Condition-H5: when/if the one or more RSs/RS resources/RS resource indexes provided in/by the indicated TCI state (e.g., of QCL-TypeD)—e.g., as specified in the implicit determination example-1-correspond to CSI-RS(s) for tracking or tracking reference signal(s)—e.g., CSI-RS(s) configured with trs-Info

For this design example (i.e., the example-II), the UE could send or transmit to the network a/the UEI beam report, in a reporting instance, comprising one or more SSBRIs—and therefore, the corresponding beam metric(s) including L1-RSRP(s)/L1-SINR(s)—each corresponding to a SSB/SSB index (as a current serving beam RS/RS resource/RS resource index or a candidate/actual new beam RS/RS resource/RS resource index in this design example that satisfies the event(s) condition(s) as defined/specified herein in the present disclosure).

In one example (example-III), a/the UE could determine or identify a first current serving beam RS/RS index/RS resource/RS resource index according to or as a SSB or SSB index, e.g., according to or following those specified in the implicit determination example-2 and/or the explicit configuration example-2 as described/specified herein in the present disclosure, and/or a second current serving beam RS/RS index/RS resource/RS resource index according to or as a (periodic) CSI-RS, CSI-RS resource or CSI-RS resource configuration index including TRS, e.g., according to or following those specified in the implicit determination example-1 and/or the explicit configuration example-1 as described/specified herein in the present disclosure, and/or the UE could determine or identify that one or more of the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure, and/or the UE could determine or identify that one or more of the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure, when/if one or more of the following conditions are achieved or satisfied.
Condition-Ia: the Type-A indicator(s), e.g., the one-bit indicator, as specified/defined herein in the present disclosure is absent/not present or configured or enabled, and/or is present/configured/enabled and set to ‘0’ (or ‘1’) or ‘disabled’ or ‘off’ or ‘sameSSB’;
Condition-Ib: the Type-A indicator(s), e.g., the one-bit indicator, as specified/defined herein in the present disclosure is present/configured/enabled and/or set to ‘1’ (or ‘0’) or ‘enabled’ or ‘on’ or ‘differentSSBs’;
Condition-Ja: the Type-B indicator(s), e.g., a one-bit, two-bit or multi-bit indicator, as specified/defined herein in the present disclosure is present/configured/enabled and/or set to ‘0’ (or ‘1’) or ‘01’ (or ‘00’, ‘10’ or ‘11’) or ‘disabled’ (or ‘enabled’) or ‘off’ (or ‘on’) or ‘ssbAsCurrentBeam’
Condition-Jb: the Type-B indicator(s), e.g., a one-bit, two-bit or multi-bit indicator, as specified/defined herein in the present disclosure is present/configured/enabled and/or set to ‘1’ (or ‘0’) or ‘00’ (or ‘01’, ‘10’ or ‘11’) or ‘enabled’ (or ‘disabled’) or ‘on’ (or ‘off’) or ‘csirsAsCurrentBeam’
Condition-Jc: the Type-B indicator(s), e.g., a one-bit, two-bit or multi-bit indicator, as specified/defined herein in the present disclosure is absent/not present or configured or enabled, and/or is present/configured/enabled and/or set to ‘10’ or ‘11’ (or ‘00’ or ‘01’) or ‘bothSSBAndCsirsAsCurrentBeam’
Condition-Ka: the UE determines or identifies that one or more of the candidate/actual candidate/new beam RS(s)/RS resource(s)/RS resource index(es) as defined/specified herein in the present disclosure is according to or as SSB(s) or SSB index(es), e.g., according to or following those specified in the implicit determination example-B and/or the implicit determination example-D and/or the explicit configuration example-B as described/specified herein in the present disclosure; specifically, for the explicit configuration example-B, the set s̅₁ of SSBs/SSB indexes as defined/specified herein in the present disclosure is provide or configured or indicated by the network
Condition-Kb: the UE determines or identifies that one or more of the candidate/actual candidate/new beam RS(s)/RS resource(s)/RS resource index(es) as defined/specified herein in the present disclosure is according to or as (periodic) CSI-RS(s), CSI-RS resource(s) or CSI-RS resource configuration index(es) including TRS(s), e.g., according to or following those specified in the implicit determination example-A and/or the implicit determination example-C and/or the explicit configuration example-A as described/specified herein in the present disclosure; specifically, for the explicit configuration example-A, the set s̅₁ of (periodic) CSI-RS resource configuration indexes as defined/specified herein in the present disclosure is provide or configured or indicated by the network
Condition-La: a set s̅₀ of SSBs/SSB indexes as defined/specified herein in the present disclosure (explicit configuration example-2) is provide or configured or indicated by the network
Condition-Lb: a set 5% of (periodic) CSI-RS resource configuration indexes as defined/specified herein in the present disclosure (explicit configuration example-1) is provide or configured or indicated by the network (e.g., the network 130)
Condition-L0: when/if the Type-C indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s)
Condition-L1: when/if the Type-D indicator(s) is present or configured or provided or enabled or set to valid value(s) including ‘1’ (or ‘0’) or ‘01’ (or ‘00’ or ‘10’ or ‘11’) or ‘on’ or ‘enabled’ in the corresponding higher layer RRC signaling(s)/parameter(s) and/or MAC CE command(s) and/or dynamic DCI based L1 signaling(s), the UE (e.g., the UE 116) could send or transmit to the network
Condition-L2: when/if the Type-E indicator(s) is not present or absent or not configured or not provided or not enabled or disabled or set to invalid value(s) or not set to valid value(s) including ‘0’ or ‘1’ or ‘00’ or ‘01’ or ‘10’ or ‘11’ or ‘on’ or ‘off’ or ‘enabled’ or ‘disabled’ or ‘csirsAsCurrentBeam’ or ‘ssbAsCurrentBeam’ or ‘default’ or set to valid value(s) including ‘0’ (or ‘1’) or ‘00’ (or ‘01’ or ‘10’ or ‘11’) or ‘off’ or ‘disabled’ or ‘default’ in the corresponding higher layer RRC signaling(s)/parameter(s) and/or MAC CE command(s) and/or dynamic DCI based L1 signaling(s)
Condition-L3: when/if the one or more RSs/RS resources/RS resource indexes provided in/by the indicated TCI state (e.g., of QCL-TypeD)—e.g., as specified in the implicit determination example-1-correspond to CSI-RS(s) for beam management—e.g., CSI-RS(s) configured with repetition or with repetition set to ‘on’
Condition-L4: when/if the one or more RSs/RS resources/RS resource indexes provided in/by the indicated TCI state (e.g., of QCL-TypeD)—e.g., as specified in the implicit determination example-1-correspond to CSI-RS(s) for tracking or tracking reference signal(s)—e.g., CSI-RS(s) configured with trs-Info

For this design example (i.e., the example-III), the UE could send or transmit to the network, in a reporting instance, a/the UEI beam report that could comprise.
one or more SSBRIs—and therefore, the corresponding beam metric(s) including L1-RSRP(s)/L1-SINR(s)—each corresponding to a SSB/SSB index (as a first current serving beam RS/RS resource/RS resource index or a candidate/actual new beam RS/RS resource/RS resource index in this design example that satisfies the event(s) condition(s) as defined/specified herein in the present disclosure), and/or
one or more CRIs—and therefore, the corresponding beam metric(s) including L1-RSRP(s)/L1-SINR(s)—each corresponding to a CSI-RS/CSI-RS resource/CSI-RS resource configuration/CSI-RS resource configuration index (as a second current serving beam RS/RS resource/RS resource index or a candidate/actual new beam RS/RS resource/RS resource index in this design example that satisfies the event(s) condition(s) as defined/specified herein in the present disclosure),
   according to or based on (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). Optionally, for this design example (i.e., the example-III), the UE could send or transmit to the network, in a first reporting instance, a/the first UEI beam report comprising one or more SSBRIs—and therefore, the corresponding beam metric(s) including L1-RSRP(s)/L1-SINR(s)—each corresponding to a SSB/SSB index (as a first current serving beam RS/RS resource/RS resource index or a candidate/actual new beam RS/RS resource/RS resource index in this design example that satisfies the event(s) condition(s) as defined/specified herein in the present disclosure). Furthermore, the UE could send or transmit to the network, in a second reporting instance, a/the second UEI beam report comprising one or more CRIs—and therefore, the corresponding beam metric(s) including L1-RSRP(s)/L1-SINR(s)—each corresponding to a CSI-RS/CSI-RS resource/CSI-RS resource configuration/CSI-RS resource configuration index (as a second current serving beam RS/RS resource/RS resource index or a candidate/actual new beam RS/RS resource/RS resource index in this design example that satisfies the event(s) condition(s) as defined/specified herein in the present disclosure). In this design example (i.e., the example-III), whether the UE could transmit or send to the network a single UEI beam report (in a single reporting instance) that could comprise resource indicator(s) corresponding to CRI(s) and/or SSBRI(s) or separate UEI beam reports (in separate reporting instances) that could separately comprise resource indicators corresponding to CRI(s) and SSBRI(s) could be based on or according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

Throughout the present disclosure, a CSI-RS or a CSI-RS resource or a CSI-RS resource configuration could correspond to or could be referred to as a CSI-RS for beam management (e.g., a CSI-RS configured with repetition or with repetition set to ‘on’), a CSI-RS for tracking or tracking reference signal (TRS)—e.g., a CSI-RS configured with trs-Info, a CSI-RS configured without repetition or with repetition set to ‘off’, and etc.

For a given event as specified/defined herein in the present disclosure (e.g., the fourth event), a/the UE could be respectively configured or provided or indicated by the network, e.g., via higher layer RRC signaling(s)/parameter(s) and/or MAC CE command(s) and/or dynamic DCI based L1 signaling(s) based on or according to a corresponding UE's capability or capability signaling, different (or separate) thresholds or different (or separate) values of a threshold (e.g., threshold-C as defined/specified in the fourth event) for different (or separate) cases of (1) when a current serving beam RS/RS resource/RS resource index is (determined, identified or configured as) a CSI-RS/CSI-RS resource/CSI-RS resource (configuration) index and/or the candidate/actual candidate/new beam RS(s)/RS resource(s)/RS resource index(es) is (determined, identified or configured as) CSI-RS(s)/CSI-RS resource(s)/CSI-RS resource (configuration) index(es) according to or following those specified herein in the present disclosure, and (2) when a current serving beam RS/RS resource/RS resource index is (determined, identified or configured as) a SSB or SSB index and/or the candidate/actual candidate/new beam RS(s)/RS resource(s)/RS resource index(es) is (determined, identified or configured as) SSB(s) or SSB index(es) according to or following those specified herein in the present disclosure. Here, the higher layer RRC signaling(s)/parameter(s) could be or could correspond to the higher layer RRC parameter(s) that provides or configures the corresponding RS(s), RS resource(s), RS resource configuration(s), RS resource configuration index(es), TCI state(s) and/or etc.; optionally, the higher layer RRC signaling(s)/parameter(s) could be or could correspond to CSI-ReportConfig, CSI-ResourceConfig, UEI-ReportConfig and/or UEI-ResourceConfig that provides or configures the corresponding UEI (beam) reporting. For the fourth event as specified/defined herein in the present disclosure,
In one example, for the example-I and/or example-III as described/specified herein in the present disclosure, and/or when/if a (second) current serving beam RS/RS resource/RS resource index is (determined, identified or configured as) a CSI-RS/CSI-RS resource/CSI-RS resource (configuration) index and/or the candidate/actual candidate/new beam RS(s)/RS resource(s)/RS resource index(es) is (determined, identified or configured as) CSI-RS(s)/CSI-RS resource(s)/CSI-RS resource (configuration) index(es) according to or following those specified herein in the present disclosure, the UE could be configured by the network a first threshold provided by Th_csirs; in this case, the UE could use or apply Th_csirs as the threshold-C as defined/specified herein in the present disclosure for comparing the radio link/beam qualities between current serving beam RS(s)/RS resource(s)/RS resource index(es) and candidate/actual candidate/new beam RS(s)/RS resource(s)/RS resource(s) when/if they both correspond to CSI-RSs/CSI-RS resources/CSI-RS resource configuration indexes as defined/specified herein in the present disclosure; more specifically, the UE could assess or evaluate whether the radio link or beam quality(s)—e.g., by measuring the L1-RSRP(s)/L1-SINR(s)—of one or more (or at least one) CSI-RSs/CSI-RS resources/CSI-RS resource configurations (as the candidate/actual candidate/new beam RS(s)/RS resource(s) in this design example) is beyond or greater than the radio link or beam quality(s)—e.g., by measuring the L1-RSRP(s)/L1-SINR(s)—of one or more CSI-RSs/CSI-RS resources/CSI-RS resource configurations (as the current serving beam RS(s)/RS resource(s) in this design example) by Th_csirs.
In another example, for the example-II and/or example-III as described/specified herein in the present disclosure, and/or when/if a (first) current serving beam RS/RS resource/RS resource index is (determined, identified or configured as) a SSB/SSB index and/or the candidate/actual candidate/new beam RS(s)/RS resource(s)/RS resource index(es) is (determined, identified or configured as) SSB(s)/SSB index(es) according to or following those specified herein in the present disclosure, the UE could be configured by the network a second threshold provided by Th_ssb; in this case, the UE could use or apply Th_ssb as the threshold-C as defined/specified herein in the present disclosure for comparing the radio link/beam qualities between current serving beam RS(s)/RS resource(s)/RS resource index(es) and candidate/actual candidate/new beam RS(s)/RS resource(s)/RS resource(s) when/if they both correspond to SSBs/SSB indexes as defined/specified herein in the present disclosure; more specifically, the UE could assess or evaluate whether the radio link or beam quality(s)—e.g., by measuring the L1-RSRP(s)/L1-SINR(s)—of one or more (or at least one) SSBs (as the candidate/actual candidate/new beam RS(s)/RS resource(s) in this design example) is beyond or greater than the radio link or beam quality(s)—e.g., by measuring the L1-RSRP(s)/L1-SINR(s)—of one or more SSBs (as the current serving beam RS(s)/RS resource(s) in this design example) by Th_ssb.

Here, the values of Th_csirs and Th_ssb could be (or could be configured to be) the same. Alternatively, or optionally, the values of Th_csirs and Th_ssb could be (or could be configured to be) different. In addition, the Th_csirs and Th_ssb could be configured or provided to the UE at the same time or simultaneously (e.g., in a/the same higher layer RRC signaling/parameter), or separately (e.g., in separate higher layer RRC signalings/parameters).
In one example, the threshold Th_csirs could be present and the threshold Th_ssb could be absent; for this case, the UE could expect that Th_ssb=Th_csirs.
In another example, the threshold Th_csirs could be present and the threshold Th_ssb could be absent; for this case, the UE could be further configured or provided by the network, e.g., via the corresponding higher layer RRC signaling(s)/parameter(s) and/or MAC CE command(s) and/or dynamic DCI based L1 signaling(s), an offset value of Th_offset. For this design example, the UE could expect that Th_ssb=Th_csirs+Th_offset.
In another example, the threshold Th_csirs could be absent and the threshold Th_ssb could be present; for this case, the UE could expect that Th_csirs=Th_ssb.
In another example, the threshold Th_csirs could be absent and the threshold Th_ssb could be present; for this case, the UE could be further configured or provided by the network, e.g., via the corresponding higher layer RRC signaling(s)/parameter(s) and/or MAC CE command(s) and/or dynamic DCI based L1 signaling(s), an offset value of Th_offset. For this design example, the UE could expect that Th_csirs=Th_ssb±Th_offset.
In another example, both the thresholds Th_csirs and Th_ssb are present.
In another example, both the thresholds Th_csirs and Th_ssb are present. For this case, the UE could still be further configured or provided by the network, e.g., via the corresponding higher layer RRC signaling(s)/parameter(s) and/or MAC CE command(s) and/or dynamic DCI based L1 signaling(s), an offset value of Th_offset. For this design example, the UE could expect that Th_csirs=Th_ssb±Th_offset and/or Th_ssb=Th_csirs+Th_offset.
In another example, neither of the thresholds Th_csirs and Th_ssb is present.

Throughout the present disclosure, a parameter being present is equivalent to being configured, provided or enabled in the corresponding higher layer RRC signaling(s)/parameter(s) and/or MAC CE command(s) and/or dynamic DCI based L1 signaling(s), and/or a parameter being absent (or not present) is equivalent to not being configured, provided or enabled or being disabled in the corresponding higher layer RRC signaling(s)/parameter(s) and/or MAC CE command(s) and/or dynamic DCI based L1 signaling(s).

A UE could indicate or send or transmit to the network, e.g., as/by/in part of their capability signaling, whether or not they can support (1) a CSI-RS, CSI-RS resource or CSI-RS resource configuration index including TRS as a current serving beam RS/RS resource/RS resource index, e.g., according to or following those specified in the implicit determination example-1 and/or the explicit configuration example-1 as described/specified herein in the present disclosure, and/or (2) a SSB or a SSB index as a current serving beam RS/RS resource/RS resource index, e.g., according to or following those specified in the implicit determination example-2 and/or the explicit configuration example-2 as described/specified herein in the present disclosure. For instance, a/the UE could indicate or send or transmit to the network a capability or capability signaling indicating the type of the RS that they can support as a current serving beam RS/RS resource, wherein the capability or capability signaling could comprise one or more of the following components:
{CSI-RS}; {SSB}; {Both CSI-RS and SSB}; and {CSI-RS, SSB}.

A UE could indicate or send or transmit to the network, e.g., as/by/in part of their capability signaling, whether or not they can support (1) a CSI-RS, CSI-RS resource or CSI-RS resource configuration index including TRS as a candidate/new beam RS/RS resource/RS resource index, e.g., according to or following those specified in the implicit determination example-A and/or the implicit determination example-C and/or the explicit configuration example-A as described/specified herein in the present disclosure, and/or (2) a SSB or a SSB index as a candidate/new beam RS/RS resource/RS resource index, e.g., according to or following those specified in the implicit determination example-B and/or the implicit determination example-D and/or the explicit configuration example-B as described/specified herein in the present disclosure. For instance, a/the UE could indicate or send or transmit to the network a capability or capability signaling indicating the type of the RS that they can support as a candidate/new beam RS/RS resource, wherein the capability or capability signaling could comprise one or more of the following components:
{CSI-RS}; {SSB}; {Both CSI-RS and SSB}; and {CSI-RS, SSB}.

The described or specified design examples, options, procedures, signaling alternatives and etc. throughout the present disclosure for the current serving beam RS(s)/RS resource(s)/RS resource index(es) can be extended or equally applied to the candidate/actual candidate/new beam RS(s)/RS resource(s)/RS resource index(es) according to or following those specified herein in the present disclosure.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities-including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

FIG. 8 illustrates an example method 800 performed by a UE in a wireless communication system according to embodiments of the present disclosure. The method 800 of FIG. 8 can be performed by any of the UEs 81-86 of FIG. 1, such as the UE 86 of FIG. 3, and a corresponding method can be performed by any of the BSs 101-103 of FIG. 1, such as BS 102 of FIG. 2. The method 800 is for illustration only and other embodiments can be used without departing from the scope of the present disclosure.

The method 800 begins with the UE transmitting an indication of support for a SSB or a CSI-RS for event evaluation or measurement reporting for UEI reporting (810). For example, in 810, the indication is included in a capability signaling of the UE. The UE then receives information related to an event in a CSI report configuration for UEI reporting (820). The UE then receives one or more first RSs associated with the CSI report configuration (830). The UE then determines a second RS from the one or more first RSs (840).

The UE then identifies an event type and an event evaluation threshold based on the information (850). For example, in 850, the event threshold has the parameter name Th_event. In various embodiments, when the one or more first RSs correspond to SSBs, the event evaluation threshold has a first value and, when the one or more first RSs correspond to CSI-RSs, the event evaluation threshold, has a second value. In various embodiments, when the one or more first RSs correspond to SSBs, the second RS is an SSB that is quasi-co-located with a RS in an TCI state and, when the one or more first RSs correspond to CSI-RSs, the second RS is the RS in the indicated TCI state.

The UE then determines an event based on the event type, the event evaluation threshold, and the second RS (860). In various embodiments, when the event type is set to ‘event1’, the event is determined when a quality metric of the second RS is lower than the event evaluation threshold, and the quality metric is a L1-RSRP. For example, the CSI report configuration includes a higher layer parameter, currentBeamInclusion, and the UEI report includes the L1-RSRP of the second RS. In another example, the L1-RSRP of the second RS is quantized relative to the event evaluation threshold. In various embodiments, when the event type is set to ‘event2’, the event is determined when a first quality metric of one of the one or more first RSs is greater than a second quality metric of the second RS by at least the event evaluation threshold, and the first and second quality metrics are L1-RSRPs. The UE then determines an UEI report including an ID of the event based on the event (870). The UE then transmits the UEI report (880).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
transmit, in a capability signaling of the UE, an indication of support for a synchronization signal/physical downlink broadcasting channel (SS/PBCH) block (SSB) or a channel state information reference signal (CSI-RS) for event evaluation or measurement reporting for UE-initiated (UEI) reporting;
receive, in a channel state information (CSI) report configuration for UEI reporting, information related to an event; and
receive one or more first reference signals (RSs) associated with the CSI report configuration; and
a processor operably coupled with the transceiver, the processor configured to:
determine a second RS from the one or more first RSs;
identify, based on the information, an event type and an event evaluation threshold, Th_event;
determine an event based on the event type, the event evaluation threshold, and the second RS; and
determine, based on the event, an UEI report including an identifier (ID) of the event,
wherein the transceiver is further configured to transmit the UEI report.

2. The UE of claim 1, wherein:
when the one or more first RSs correspond to SSBs, the event evaluation threshold, Th_event, has a first value; and
when the one or more first RSs correspond to CSI-RSs, the event evaluation threshold, Th_event, has a second value.

3. The UE of claim 1, wherein:
when the one or more first RSs correspond to SSBs, the second RS is an SSB that is quasi-co-located with a RS in an indicated transmission configuration indication (TCI) state; and
when the one or more first RSs correspond to CSI-RSs, the second RS is the RS in the indicated TCI state.

4. The UE of claim 1, wherein:
when the event type is set to ‘event1’, the event is determined when a quality metric of the second RS is lower than the event evaluation threshold, and
the quality metric is a layer-1 reference signal received power (L1-RSRP).

5. The UE of claim 4, wherein:
the CSI report configuration includes a higher layer parameter, currentBeamInclusion, and
the UEI report includes the L1-RSRP of the second RS.

6. The UE of claim 4, wherein the L1-RSRP of the second RS is quantized relative to the event evaluation threshold.

7. The UE of claim 1, wherein:
when the event type is set to ‘event2’, the event is determined when a first quality metric of one of the one or more first RSs is greater than a second quality metric of the second RS by at least the event evaluation threshold, and
the first and second quality metrics are layer-1 reference signal received powers (L1-RSRPs).

8. A base station (BS), comprising:
a processor; and
a transceiver operably coupled with the processor, the transceiver configured to:
receive, in a capability signaling of a user equipment (UE), an indication of support for a synchronization signal/physical downlink broadcasting channel (SS/PBCH) block (SSB) or a channel state information reference signal (CSI-RS) for event evaluation or measurement reporting for UE-initiated (UEI) reporting;
transmit, in a channel state information (CSI) report configuration for UEI reporting, information related to an event, wherein the information indicates an event type and an event evaluation threshold, Th_event;
transmit one or more first reference signals (RSs) associated with the CSI report configuration; and
receive, after occurrence of the event, an UEI report including an identifier (ID) of the event,
wherein the event is based on the event type, the event evaluation threshold, and a second RS from the one or more first RSs.

9. The BS of claim 8, wherein:
when the one or more first RSs correspond to SSBs, the event evaluation threshold, Th_event, has a first value; and
when the one or more first RSs correspond to CSI-RSs, the event evaluation threshold, Th_event, has a second value.

10. The BS of claim 8, wherein:
when the one or more first RSs correspond to SSBs, the second RS is an SSB that is quasi-co-located with a RS in an indicated transmission configuration indication (TCI) state; and
when the one or more first RSs correspond to CSI-RSs, the second RS is the RS in the indicated TCI state.

11. The BS of claim 8, wherein:
when the event type is set to ‘event1’, the event occurs when a quality metric of the second RS is lower than the event evaluation threshold, and
the quality metric is a layer-1 reference signal received power (L1-RSRP).

12. The BS of claim 11, wherein:
the CSI report configuration includes a higher layer parameter, currentBeamInclusion, and
the UEI report includes the L1-RSRP of the second RS.

13. The BS of claim 11, wherein the L1-RSRP of the second RS is quantized relative to the event evaluation threshold.

14. The BS of claim 8, wherein:
when the event type is set to ‘event2’, the event occurs when a first quality metric of one of the one or more first RSs is greater than a second quality metric of the second RS by at least the event evaluation threshold, and
the first and second quality metrics are layer-1 reference signal received powers (L1-RSRPs).

15. A method performed by a user equipment (UE), the method comprising:
transmitting, in a capability signaling of the UE, an indication of support for a synchronization signal/physical downlink broadcasting channel (SS/PBCH) block (SSB) or a channel state information reference signal (CSI-RS) for event evaluation or measurement reporting for UE-initiated (UEI) reporting;
receiving, in a channel state information (CSI) report configuration for UEI reporting, information related to an event;
receiving one or more first reference signals (RSs) associated with the CSI report configuration;
determining a second RS from the one or more first RSs;
identifying, based on the information, an event type and an event evaluation threshold, Th_event;
determining an event based on the event type, the event evaluation threshold, and the second RS;
determining, based on the event, an UEI report including an identifier (ID) of the event; and
transmitting the UEI report.

16. The method of claim 15, wherein:
when the one or more first RSs correspond to SSBs, the event evaluation threshold, Th_event, has a first value; and
when the one or more first RSs correspond to CSI-RSs, the event evaluation threshold, Th_event, has a second value.

17. The method of claim 15, wherein:
when the one or more first RSs correspond to SSBs, the second RS is an SSB that is quasi-co-located with a RS in an indicated transmission configuration indication (TCI) state; and
when the one or more first RSs correspond to CSI-RSs, the second RS is the RS in the indicated TCI state.

18. The method of claim 15, wherein:
when the event type is set to ‘event1’, the event is determined when a quality metric of the second RS is lower than the event evaluation threshold, and
the quality metric is a layer-1 reference signal received power (L1-RSRP).

19. The method of claim 18, wherein:
the CSI report configuration includes a higher layer parameter, currentBeamInclusion, and
the UEI report includes the L1-RSRP of the second RS.

20. The method of claim 18, wherein the L1-RSRP of the second RS is quantized relative to the event evaluation threshold.
